(19) United States
(12) Patent Application Publication
(10) Pub. No.: US 2004/0158494 A1
(43) Pub. Date: Aug. 12, 2004

(54) Restaurant automation system

(76) Inventor: Yogin P. Suthar, White Plains, NY (US)

Correspondence Address: Karl F. Milde, Jr., Esq., MILDE & HOFFBERG, LLP, Suite 460, 10 Bank Street, White Plains, NY, 10606, US

(21) Appl. No.: 10/772,800

(22) Filed: Feb. 5, 2004

Related U.S. Application Data
(60) Provisional application No. 60/445,361, filed on Feb. 5, 2003.

(51) Int. Cl. G06F 17/60

(52) U.S. Cl. 705/15

(57) ABSTRACT

The present invention provides a restaurant automation system with greater efficiencies for the restaurant owner and greater ease for the diner through the use of wireless electronic menus with which the individual diner can communicate an order to the central server which communicates to a kitchen display, and receives a message when order preparation has begun; the central server being also in communication with a payment station, which generates a bill at the direction of the diner.

### FIELD OF THE INVENTION

The present invention relates to automated restaurant management systems, restaurant entertainment systems, and to the automation of order taking, bill paying and other services.

### BACKGROUND OF THE INVENTION

Many restaurants run on thin profit margins. Instituting operational efficiencies in a restaurant can have an enormous impact on the bottom line. Instituting efficiencies can, e.g., increase the revenue per seating, and/or to increase the number of sittings per day. In addition, certain efficiencies and/or customer services produce the ability to attract and retain more patrons.

There has been no shortage of proposals to make the backend (kitchen, waiter, inventory control, supply ordering, etc.) operations of restaurants more efficient. More recently, the use of small, powerful computing devices, has been proposed to create efficiencies in the front-end operations (customer interfacing).

The proposed improvements in operational efficiencies be inexpensive, and have a short return on investment (ROI). For restaurants, a large capital investment generally presents a barrier to the adoption of otherwise beneficial solutions. As a rule, the cost of a proposed improvement must be offset by the operational efficiencies it provides.

In addition, for restaurant customers, both ease-of-use and elegance are significant factors in determining the success of a new system. Any new restaurant system must not present a learning burden to the diner, but should be intuitive, allowing the diner to succeed in using it the first time.

It has been proposed to improve the efficiencies in restaurant operations by permitting waiters to electronically transmit orders to the kitchen. Indeed, some systems permit the customer or diner to directly send orders to the kitchen.

For example, U.S. Pat. No. 6,425,524 to Pentel describes a remote ordering system using hand-held devices such as at 112, in FIG. 12a, which transmit orders to an order station. The hand-held device utilizes key pad entry for placing an order, which may be displayed on an LCD screen before sending the order to the order station. The menu is presented on a separate apparatus called a display device that displays the ordering numbers associated with different food orders. It may also have a screen displaying the order message received. In its broadest application, the restaurateur may also post a pre-viewing menu on a website, and the components of the hand-held device imbedded in a cell phone. Though the patent describes an “order ready” signaling means, and a “change/recall” order means, there is no message for when the food preparation has started. A customer order number may be sent to the hand-held device, but there is no means described for assigning a table ID. Pentel also discloses an ordering system for a drive-thru restaurant (FIGS. 1, 1a, and 2) wherein the transmission from the hand-held device 12 may be a short range line-of-sight remote control device transmitting to a drive-up display menu. The hand-held devices have key pads, which are impractical in a restaurant/dining environment full of drips and crumbs, which can jam the keys. No graphic representation of the food items available is presented on the screen. Nor are there pop-up display of food offerings to explore further and further details of the menu.

U.S. Pat. 5,838,798 to Smith discloses a hand-held portable device for placing an order to a server, and then to a kitchen terminal. However, these devices are intended to be operated by the waiter, hence, the level of detail, comprising graphic representations of the food offering need be minimal, as the-waiter knows the menu.

TouchPak sells a system, called an entertainment portal. Customers waiting to be seated may be presented with the device, from which they can pre-view a menu, preorder, surf the Internet and receive a table ready signal.

In a restaurant where customers are seated before ordering, an interactive system has been proposed according to which one interactive table display must be used by each diner at the table. (U.S. Pat. No. 4,553,222, to Kurland, and International Application WO 01/35716) These systems vary from the traditional arrangement wherein each diner is permitted his/her own menu, to consult individually. Some of the systems proposed for increased efficiency require a change in operational steps, or interactive sequences of conventional dining, and thereby present an adaptability barrier to widespread customer acceptance. What is needed is a solution that is familiar in its presentation and yet, substantially rich in underlying functionality.

Despite the plethora of new restaurant management system solutions, the customer's experience in a restaurant has hardly changed through the years. In a traditional restaurant, a large percentage of time is actually spent waiting for the waiter, rather than eating. First, one must wait for the waiter to take an order. The length of this waiting period bears no relationship to the hunger or desires of the customer. Next, one must interrupt eating while waiting for the opportunity to catch the waiter's attention if a water or soda refill, or other adjunct item, such as a relish or dressing, is necessary. Finally, among other services, one must wait for the waiter to provide a check and then, wait again, for him to return with the receipt. Not only does this impose suffrage on the customer in terms of waiting, but it may also preclude synchronization of the various courses of the meal. Since up to half the time spent in the restaurant may be spent waiting for the waiter, the restaurant also loses revenue, as the table cannot be turned for the next customer. During an evening, up to an entire table service may be lost.

The present invention not only provides increased efficiencies in the operation of the restaurant, but also provides vast enhancements in the menu, ease of payment, food/nutrition information and/or entertainment provided to the customer, suggestive selling technologies with no loss in comfort or elegance. In a preferred embodiment, the present invention provides a personalization/benefits system customized to the dining patterns of each diner. The present invention hence presents a win-win solution for the restaurateur and the diner and the restaurant industry. Perhaps most significantly, the present invention eliminates or substantially reduces the need for waiters/cashiers/hostesses thereby introducing a novel operational model for the restaurant industry that can result in favorable cash flow economics.

Published International Application WO 01/82203, which shows a table terminal device that provides customers access to the Internet, but the system must be shared by all at the table and hence provides limited entertainment possibilities.

### SUMMARY OF THE INVENTION

In its preferred embodiment, the present invention provides a restaurant automation system (RAS) which comprises at least an Automated Ordering System (AOS) component system, and may also include at least one of following component systems; the Waiter Call System (WCS), the Reception Management System (RMS), and the Customer Personalization System (CPS). The WCS and the AOS may be implemented as stand alone systems.

The RAS System

The over-arching RAS System includes a compute Server with applications common to the component systems. These applications include the Configuration Function and Service Management Function, as described below. The RAS may also include video cameras in the kitchen, and perhaps the reception area, with the streaming video sent by the server to E-menus, for diner viewing; or to monitors in the reception area, for diners waiting to be seated. The RAS for a number of restaurants may be combined through the use of a Central Server at a Central Facility.

The Automated Ordering System

The Automated Ordering System (AOS) is the core component of the Restaurant Automation System and consists of the AOS function on the RAS compute server, the E-Menu, an order display in wireless communication with the server, and, optionally, the Payment Station, as its main components. The E-Menu represents a significant evolution in restaurant service technology and distinguishes the AOS and RAS of the present invention from other suggested automation systems. In its very simplest form, the E-Menu may be a non-communicating display device that provides users with a platform for the display of rich content information provided by a restaurant compute server, and perhaps some entertainment; however, in most embodiments of the E-menu, it will provide a low-cost interactive device for ordering, and, preferably, Internet access. Whereas many applications for the E-Menu are envisioned, in the current embodiment, the E-Menu is used directly by individual restaurant diners (as opposed to waiters or cashiers). The diners may use the E-menu to access text, graphical, video, audio information relating to the restaurant's menu, as well as other relevant information regarding the chef, restaurant background, live kitchen video, etc. Far more information can be displayed on an E-menu than a paper menu or blackboard. It also provides an interface through which the diners may directly place food orders with the kitchen, receive status on order preparation, direct the generation and payment of bills, access the Internet, etc.

The E-Menu represents an evolution of the traditional hardcopy menu and provides a number of usability and economic benefits. At the same time, the E-Menu is designed to be gracefully and to be easily adopted by the general public because of its similarity in basic operational sequence to the traditional menu and human interface design.

The AOS provides several benefits to both the customer and the restaurant industry. First, it removes customer dependency upon the waiter. The E-Menu, when used as part of the overall Automated Ordering System, grants full control of the dining experience from information access, food selection, bill payment, meal course timing, entertainment, etc. directly to the customer. Since dependence on the waiter for common functions is reduced, dining times to can be more controlled and predictable. This allows customers to dine out in situations where they otherwise would not have because of perceived time constraints. This leads to a simultaneous benefit for the restaurant industry.

Second, since the AOS and E-Menu provide rich content information on the meals (photos, ingredients, preparation video clips, nutrition, specials, etc.) in a dynamic format, it makes it easy for customers to be more educated about what they are ordering. For example, photos provide a clear depiction of what the meal will look like prior to ordering. The E-menu also provides customers with far richer information content than a waiter can provide, at their fingertips, thereby facilitating a more rapid and well informed meal selection process. This eliminates unexpected surprises regarding portion size, appearance, etc., thereby increasing satisfaction with the dining experience. This thereby provides obvious benefits to the restaurant industry.

Third, the E-Menu and the Restaurant Automation System in general, significantly reduce the amount of time diners waste in a restaurant waiting for services and items because of waiter/cashier dependency. This allows the restaurant to turn the table more quickly resulting in a greater number of table services, which in turn, results in greater revenue.

Fourth, the E-Menu serves as a dynamic advertising medium through which the restaurant industry may derive an additional revenue stream.

Fifth, the AOS increases the restaurant's ability to quickly adapt to changing tastes, styles, specials, etc. by providing a menu platform that can be updated dynamically. Specifically, once menu changes have been made in the RAS compute server, all the E-menus have immediate access to the updated information. In addition, the entire style, motif or design of the restaurant may be adjusted rapidly by changes made at the server.

Sixth, the AOS system allows restaurants to reach into markets more easily by providing facilities for multilingual menu presentations, multilingual entertainment, presentation of price information in various currencies (for tourist areas), etc.

Seventh, the AOS allows for the customization of a table's ambiance via a jukebox function by allowing specific music files to be streamed to an E-Menu device. Additionally, specific pre-determined mood selections may be chosen with an appropriate collection of music files. This allows a restaurant to appeal to a larger market.

Eighth, the AOS system provides single and multiplayer games and entertainment for all, but specifically for children. This will have a significant impact on family oriented restaurants that currently rely on paper activities and crayons to keep children occupied and non-disruptive. The present invention extends the entertainment function by providing access to single player or interactive multi-player games, which provides a means of occupying children during the meal. This opens the restaurant market to a large audience: families with children who would not otherwise chose to dine out.

Ninth, the AOS provides a suggestive selling function that makes accompanying recommendations to selections made by the diner. For example, specific wines may be suggested to accompany particular meals.

Tenth, the AOS can provide streaming video of restaurant operations; to both the customers and the management.

Eleventh, restaurant operations may be organized and streamlined. For instance, the E-menu can communicate orders to the appropriate section of the kitchen; dessert orders to those who make-up the dessert orders, and entree orders to those who prepared the entrees. In addition, the overall functioning of the restaurant may be examined by reviewing the communications through the AOS.

The E-Menu may be approximately the size of a traditional menu. It can present the menu contents in a familiar way on a large touch sensitive LCD, OLED (Organic Light Emitting Diode), Dot Matrix, or other display with the additional functionality of presenting rich content information related to the restaurant, chef, meals, etc. The E-Menu may also provide a web browser or similar platform by means by which diners can access a restaurant's web server for web pages that define the restaurant's menu, specials, etc. The restaurant's web server (running on the RAS compute server) accesses a (preferably) broadband Internet connection and provides a proxy server function such that, when permitted, diners may access the Internet from their E-Menu.

In an alternative embodiment, the E-Menu may be a light weight display appliance in terms of processing requirements, power requirements, software, cost, etc. that simply displays pre-processed graphical data from the restaurant's RAS compute server. In this embodiment, the RAS is provided with one or more docking stations for the E-menus, or Viewing Tablets, for reprogramming, and perhaps recharging the device. The docking station(s) are connected to the Server, and reprogramming may be done through e.g., the kitchen order display.

Preferably, the E-Menu has a standard wireless network interface and communicates over a standard wireless Network to a Restaurant Automation System compute server (compute device). The RAS compute server hosts the central intelligence and functions of the overall RAS system within a RAS equipped restaurant. The AOS function is one such function.

The Automated Ordering System also automates the process of bill payment and reduces dependence on the waiter. The service staff will still be needed for cash payment. At any time during the dining process, a customer can request to have his table order tallied and sent to a Payment Station at which he may make payment. Various billing schemes per table can also be facilitated.

The Waiter Call System

The Waiter Call System (WCS) includes a Table Call Unit that provides customers with an efficient means to attract the attention of the common service staff, and to provide an indication of what they desire. In a preferred embodiment, the system utilizes various colored lights in an appropriately decorative tabletop display, called a Table Call Unit, to convey the message. If desired, such as when a line-of-sight viewing of the Table Call Unit is not feasible, a more centrally located Call Status Display, detailing the messages from a number of tables, can be used. Any member of the common service personnel pool can attend:to the request. The specific color or light pattern of the request can identify what is requested. After the request has been satisfied, the WCS Function of the RAS server stores information related to the request and its service in the common data store for Quality of Service (QOS) gauging and reporting.

Diners using the Waiter Call System do not have to waste time catching the attention of a particular waiter. Instead, the WCS sends a clear signal that is visible to any member of the common service pool. Using the color of the signal to convey a basic message as to what is desired avoids the traditional waiter double-trip (waiter first comes to ask what you want and then goes off again to get it). This saves time in two ways. First, as any member of the service staff that is available can satisfy the request, the time benefits of a multiple server queuing model are realized. Second, there is no longer a need to visually catch the attention of a specific waiter, as any member of the common service pool can readily see the visible light.

The WCS and the RAS in general, prescribe a different approach to the traditional restaurant service operational model. Whereas the traditional restaurant assigns waiters to specific tables and areas, the Restaurant Automation System introduces the concept of a common pool of service personnel that service the entire restaurant. The model of the WCS is akin to the efficient single queue-multiple server system for service in such facilities as banks.

The Reception Management System

The Automated Ordering System function in the RAS compute server maintains information regarding the dining status at each table, such as what has been ordered (appetizer, main course, coffee, etc), the time elapsed, bill requested, etc. This information is fed to the Reception Management System (RMS) Function on the RAS server, which determines the expected wait time for each table. This wait time may be displayed on a Reception Display in the reception area. Arriving customers can enter their names in lists, or queues, for tables of a specific size, based on this expected wait time information.

The Reception Management System eliminates the need for human receptionists to guess, and, perhaps, to inaccurately estimate wait times for tables of various capacities.

The RMS may also allow the service staff to accept call-in reservations and enter these reservations into the RMS's scheduling function via the Reservation Display. The RMS coordinates the scheduling of tables based on call-in reservations, walk-in customers who enter into queues, and expected table wait time information based on real-time dining status.

The RMS may be set to calculate table wait times based on real time dining status information for the particular restaurant, and allocates tables based on input from the Reception Display and the Reservation Display.

The RMS may be used in conjunction with current systems used to call waiting customers, such as blinking drink coasters, and may also offer an optional restaurant mapping application that facilitates customer self-seating.

The Customer Personalization System

The customer and restaurant intelligence of the Restaurant Automation System within a restaurant resides in the main RAS compute server. This server maintains the restaurant menu, chef information, restaurant history, hyperlinks to advertiser's website, table status, and other rich content and makes it available to the E-Menu devices, Reception Display, Kitchen Order Display, and other displays of the restaurant's RAS. The RAS compute server may also maintain information on Internet web sites visited by diners (but may not have the capability of identifying who visited what site), food-ordering patterns, dining times per table, throughout the day, etc. All this information can be used by the restaurant managers and by restaurant marketing organizations to develop systems and food products better suited for the restaurant industry.

The Service Management Function, one of the RAS common functions (described later) running on the RAS compute server, provides a means of regularly compiling information for evaluation of the functioning of a single restaurant, and can be sent to the RAS Central Service Center where it can be-combined with information of other restaurants under common management, to be reviewed by the Central Service Center personnel. Information from the data store of each restaurant's RAS Compute Server is automatically transmitted to the RAS Central Server located at the RAS Central Service Center via the Internet link or via a dial-up means. This allows managers of individual restaurants, and the RAS Central Service Center personnel to identify trends and track performance and error statistics on each restaurant's RAS implementation. The intention of this “call-home” system is to allow the RAS Central Service personnel to proactively monitor the effectiveness of the Restaurant Automation System at each establishment and to proactively take action to upgrade or replace systems/components before failure. This alleviates the restaurateur from the burden of managing the RAS system thereby reducing costs and allowing him to focus on his primary business of food preparation and service.

Another advantage to the collection of restaurant and customer intelligence on the RAS system is that it allows personalization of services for specific diners based on patronage frequency and dining patterns. For example, if a specific diner frequents RAS equipped restaurants or shows a preference for kosher meals based on the information in the data store of the RAS Central Service Center server, the RAS system may apply discounts to his bill or may provide focused meal advertising, specials, or suggestions via the E-Menu platform. This collection of data essentially allows for the creation of an automated and customized “frequent diner” program for the restaurant industry.

There are a number of RAS system functions common to the component systems. For instance, a common data store provides a data repository that is shared by all four component systems. A common Service Management function monitors effectiveness and performance of the restaurant's RAS system and communicates this information to the RAS Central Service Center. A Web Server function provides access to the RAS customer functions and the data store for all E-Menus and interactive displays in the RAS system. A common Configuration function allows restaurant management to easily configure various aspects of the RAS implementation to formulate menu content and track performance.

It is the intention of the current invention to not only provide significant increases in operational efficiency, but by its nature, to provide a near-zero ROI or time to recover the investment made in the solution. It is also the intention of this invention to overcome the economic and adoptability barriers faced by current solutions.

These objects, as well as other objects which will become apparent from the discussion that follows, are achieved, in accordance with the present invention, which comprises a RAS comprising an AOS including an electronic menu, and, optionally, a WCS, a RMS and/or a CPS.

Another embodiment of the invention comprises the Waiter Call System, which may be implemented as a stand alone Table Call Unit, with or without a decorative component. This embodiment may also include a timer display and/or a Call Status Display. If desired, a server may be added to the Water call system, with the Table Call Unit in wireless communication with the server, which is tracking restaurant management data related to the Waiter call System. This embodiment of the invention requires little beginning investment, but provides considerable value for the diner and the restaurant owner.

Another embodiment of the invention is the stand alone AOS System, applicable to drive thru restaurants, or e.g., service bays of auto repair shops, wherein the “kitchen order display” is replaced by an Order Display.

For a full understanding of the present invention, reference should now be made to the following detailed description of the preferred embodiments of the invention as illustrated in the accompanying drawings.

### BRIEF DESCRIPTION OF THE DRAWINGS

FIG. 1 illustrates the overall Restaurant Automation System Product Structure, comprising four component functions of a preferred embodiment of the present invention.

FIG. 2 is a schematic of the overall Restaurant Automation System Architecture of a preferred embodiment of the present invention.

FIG. 3 is a schematic of an alternative overall Restaurant Automation System architecture of a preferred embodiment of the present invention, having a different software framework/E-Menu architecture. Note that the wireless networking technology shown uses 802.11x and TCP/IP standards. This is one implementation option.

FIG. 4 illustrates a second alternative overall architecture of the Restaurant Automation System of a preferred embodiment of the present invention, having another software framework/E-Menu architecture. Note that the wireless networking technology shown uses 802.11x and TCP/IP standards. This is one implementation option.

FIG. 5 illustrates the home screen of the Menu Modify function of a preferred embodiment of the present invention accessed through the Kitchen Order Display.

FIG. 6 illustrates the Menu Modify function screen for a specific item in the menu according to a preferred embodiment of the present invention.

FIG. 7 illustrates the Waiter Call System architecture of a preferred embodiment of the present invention.

FIG. 8 illustrates the Waiter Call System's Table Call Unit used by diners to call the attention of the service staff.

FIG. 9 illustrates the Call Status Display system according to preferred embodiment of the present invention.

FIG. 10 illustrates the Service Call Process Flow associated with the Waiter Call System of a preferred embodiment of the present invention.

FIG. 11 illustrates the overall architecture of an Automated Ordering System according to a preferred embodiment of the present invention, and includes a drive-thru operation.

FIG. 12 illustrates a preferred embodiment of the E-Menu.

FIG. 13 illustrates a preferred Kitchen Order Display Screen of a preferred embodiment of the present invention.

FIG. 14 illustrates one embodiment of a Payment Station, which consists of a processor with a wireless network interface and a touch screen monitor.

FIG. 15 illustrates the simplified Bill Payment Process Flow for customers making cash payment.

FIG. 16 illustrates the Table Payment Display screen (on the Payment Station Monitor) showing the payment status of all tables.

FIG. 17 illustrates the simplified Bill Payment Process Flow for customers making credit card payment.

FIG. 18 illustrates the simplified Individual Bill Payment Process Flow for individual table diners making credit card payments.

FIG. 19 illustrates the simplified Ordering and Process flow, with confirmation, for one alternative method of a party of three ordering a meal.

FIG. 20 illustrates the simplified Ordering and Process Flow, with confirmation, for a second alternative method of a party of three ordering a meal.

FIG. 21 illustrates the Reception Management System architecture.

FIG. 22 illustrates the Reception Management System Table Wait Time Summary screen according to a preferred embodiment of the present invention.

FIG. 23 illustrates the Reception Management System Join Queue screen giving customers information on wait time, and the ability to enter a queue to wait for a table according to a preferred embodiment of the present invention.

FIG. 24 illustrates the Reception Process Flow of the Reservation Management System for a customer entering a full restaurant who decides to wait for a table.

FIG. 25 illustrates the Customer Personalization System architecture.

FIG. 26 illustrates the Personalization Function Process Flow for a customer participating in the Customer Personalization System.

FIG. 27 illustrates a sample home screen on an E-menu.

FIG. 28 illustrates the main menu screen from which diners can navigate into sub menus, according to a preferred embodiment of the present invention.

FIG. 29 illustrates a sample home screen of a preferred embodiment of the E-Menu for Internet surfing.

FIG. 30 illustrates a detailed description screen of a preferred E-menu that provides more information on a particular menu choice.

FIG. 31 illustrates a sub menu for a particular meal course e.g., wine list.

FIG. 32 illustrates the Internet access screen of a preferred embodiment of the E-Menu in which diners can type in a specific URL to visit a specific web site.

FIG. 33 illustrates the split screen of a preferred E-Menu that allows courses to be viewed simultaneously.

FIG. 34 illustrates a photo screen of a menu item, provided according to a preferred embodiment of the E-menu of the present invention.

FIG. 35 illustrates an E-Menu screen from which a display filter may be applied to the menu items presented on the E-Menu.

FIG. 36 illustrates a bi-fold E-menu, with two screens.

FIG. 37 illustrates a preferred embodiment of the present invention that includes video cameras, which provide streaming video of restaurant operations.

FIG. 38 illustrates a foldable/flexible E-menu.

### DESCRIPTION OF THE PREFERRED EMBODIMENTS

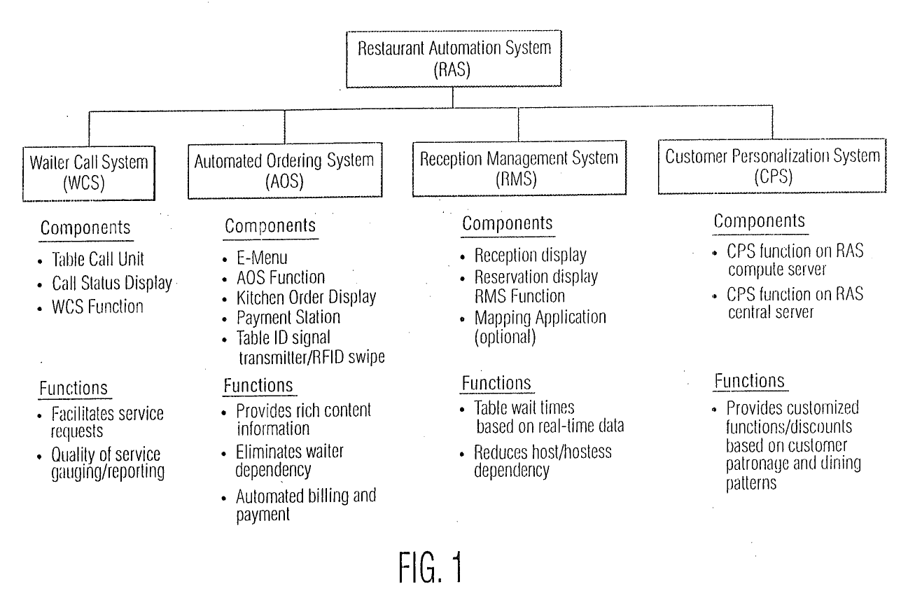

The preferred embodiments of the present invention will now be described with reference to FIGS. 1-38 of the drawings. Identical elements in the various figures are designated with the same reference numerals.

The Restaurant Automation System (RAS) represents a significant evolution in the applied technology and improved processing for the service industry, and particularly for the restaurant industry. The Restaurant Automation System reflects current trends in consumer technology and Internet market space and provides benefits for both the consumer/diner and the restaurant industry.

The Restaurant Automation System is an overall system that gives the customer greater control over the dining experience, while decreasing expenses for the restaurant industry. Its most significant component is the E-Menu, a remarkable evolution of the traditional hard copy menu. The E-Menu essentially allows a restaurant diner to transfer orders directly to the kitchen thereby bypassing the waiter, and ending the traditional waiter dependency. Herein lies a significant distinction between the Restaurant Automation System and other automation systems that give only the waiter the means to automatically and wirelessly transfer table orders to the kitchen. Whereas there are benefits to be realized with this incremental improvement in technology, from the customer's perspective the basic problem of waiter dependency is not abated. The E-Menu puts total control of the dining experience, from menu review to bill payment, in the hands of the customer.

There are other systems that allow the customer to directly interface with the kitchen, as described in the Background of the Invention, above. Most such systems are terminal based and involve a large terminal or Personal Computer (PC) like device that must be shared by customers at a table. Some use a cumbersome and impractical alphanumeric interface. None of these systems offer a device that is menu-like in its approach, feel, and interface. The E-Menu is essentially an electronic version of a traditional hard-copy menu as far as customer interfacing is concerned thereby requiring minimum transitional effort and streamlining the adoption process. By leveraging recent technologies such as flexible and foldable LCD displays, flexible, foldable and rollable Organic Light Emitting Diodes (OLEDs), flexible thin batteries, etc. the E-Menu can truly replicate the weight, feel, flexibility, and multi-panel view of a traditional menu. However, the E-menu, and certainly the Displays of the present invention, may use the older, Dot Matrix screen.

The E-Menu leverages current trends in the consumer-oriented Information Technology (IT) market. With the increasing use of Personal Digital Assistants (PDAs), tablet PCs, and highly functional cellular phones as mobile instruments of Internet access, the E-Menu is designed to be familiar to the increasingly technology savvy population. Yet, the E-Menu's human interface design allows it to be adopted easily by the general population. The E-Menu not only provides a direct interactive link to a restaurant's information database, but also serves as a low-cost appliance for Internet access that is available to every restaurant customer.

Today's PDAs are increasingly providing integrated network and Internet access capabilities. However, PDAs are too small, and too expensive to replace the traditional hard copy menu. Restaurant patrons are familiar with large menus that traditionally allow viewing at least two pages simultaneously, and that allow quick scanning of various dining courses at a glance. Today's new tablet PCs provide a large viewing area but are fully functional PCs and are therefore too expensive and large to deploy to each diner. The E-menu represents a low-cost, large display, interactive appliance suited for one specific function, and hence, produced at a low enough cost to justify its deployment to each restaurant patron.

The E-Menu can be used as an advertising medium to provide an additional revenue stream for the restaurant. In addition, the E-menu can display Internet web pages. The fact that the Internet can be accessed from such a device in a restaurant will, in itself, serve to draw additional clients and increase revenue. Such restaurants may charge a premium for their food. Alternatively, incentive programs may be developed to increase revenue. For example, if a table's order exceeds $50, Internet access is granted to that table. Or, Internet access may be provided if a certain special is ordered.

While the Restaurant Automation System (RAS) is a set of solutions designed to automate the restaurant industry, it is broadly applicable to many service oriented business operations. For the restaurant business, this automation will result in reduced operational costs and increased revenue. For the restaurant customer, use of the Restaurant Automation System will result in greater control over the dining experience and a faster, more efficient and more enjoyable dining experience.

In its largest embodiment, the Restaurant Automation System is designed with four component systems (WCS, AOS, RMS, CPS), each of which may be separately tailored to the particular restaurant and which can be separately upgraded. The Restaurant Automation System permits and encourages the use of a common pool of restaurant service personnel in contrast to the traditional model in which a particular waiter/waitress is designated to serve a group of tables. This alters the system to a single queue-multi server system such as a bank queue; thereby reducing expected wait times for service. Additionally, this system ensures faster customer seating because the traditional round-robin seating rules used to fairly divide the customers among the waiters/waitresses is eliminated.

General Architecture, FIGS. 1-4

FIG. 1 illustrates the overall RAS product structure for a preferred embodiment of the Restaurant Automation System of the present invention. FIG. 1 identifies the four component systems of the RAS and their functions. The AOS is the core of the RAS. The WCS, RMS and CPS may be readily combined with the AOS, for greater efficiencies and profit. The components and functioning of the component systems will be described below in relation to the system architecture.

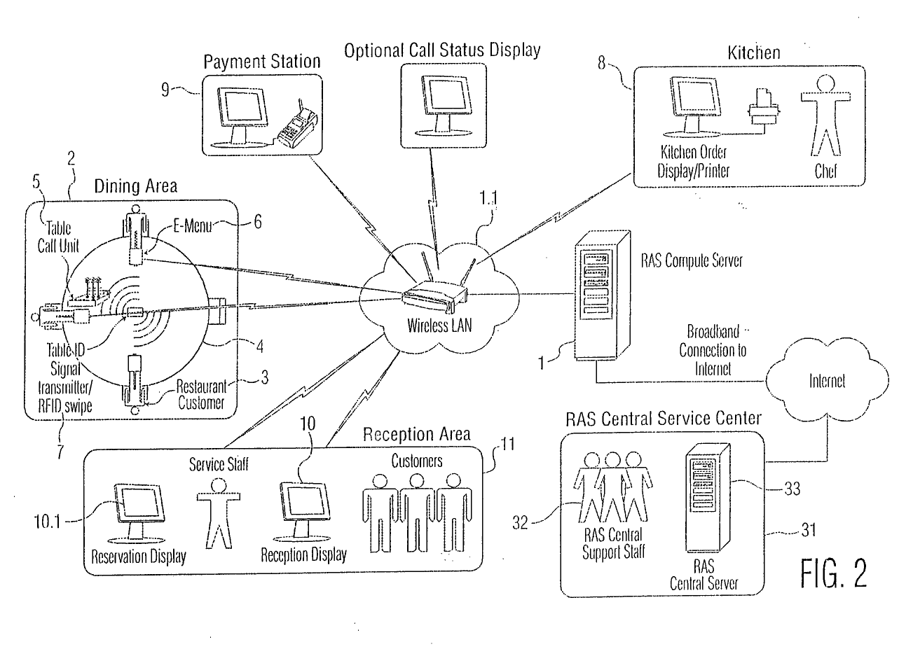

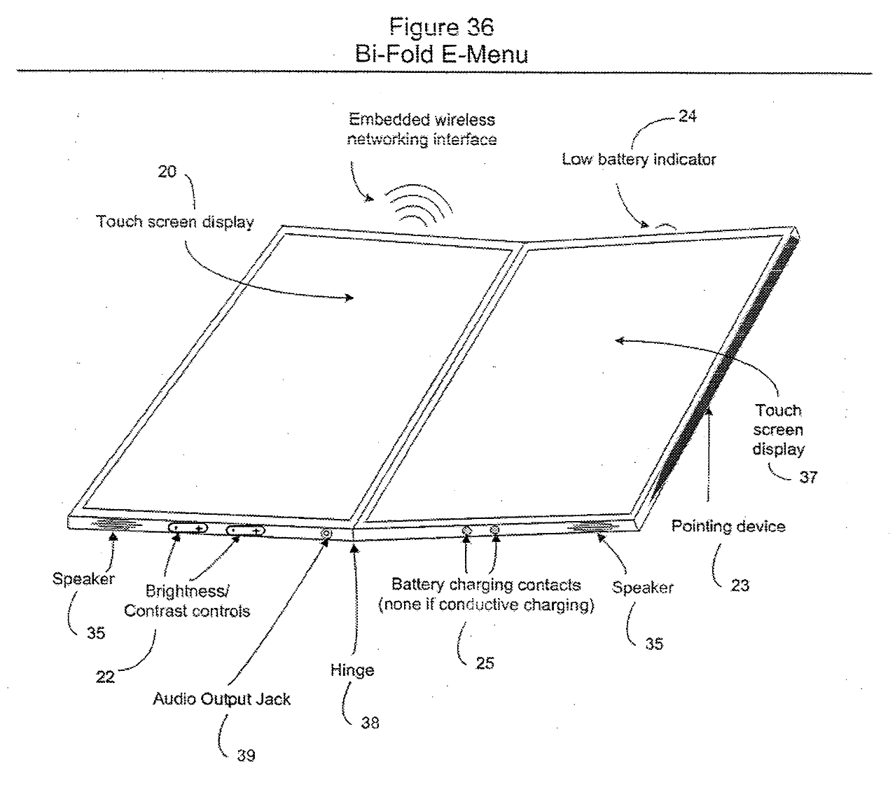

FIG. 2 depicts the overall architecture of a RAS. Note that all components depicted are located within a RAS equipped restaurant except for the Internet and the RAS Central Service Center. The RAS coordinates the activities in a number of areas of the restaurant. The system depends on the RAS Compute Server, 1, directs the communication between the various interactive displays and E-Menus. The RAS Compute;Server runs all the software applications and functional processes that provide the intelligence of the Restaurant Automation System within the restaurant and maintains the restaurant's central data store. The infrastructure for communication between the RAS Compute Server and the various displays and E-Menus is provided by means of a wireless network. This may be implemented using a wireless Local Area Network based on 802.11x standards, or may be based on wireless cellular technology. Within the dining area, 2, customers/diners, 3, are seated around the table, 4. The table is provided with a Table Call Unit, 5. Each of the customers/diners is provided with an E-menu, 6. The table may also be provided with a separate Table ID signal swipe/generator, 7. Using the Table Call Unit, the customers may summon a waiter at will, but more particularly, may indicate to the service staff, a simple specific request such as a desire for more bread or another drink. Using the E-menus, each of the customers may explore the menu, requesting details on any particular menu item, place and confirm an order, follow the status of an order, etc. Specific tables (premium, by reservation, or other criteria) may be fitted with small speakers with which an E-Menu may interface. The E-Menu may receive streaming audio files that may be heard via the E-Menu's built-in speakers or via the table's speaker system. This feature will be more fully described in relation to FIGS. 36-38.

Within the food preparation or kitchen area, 8, the orders placed and confirmed via the E-menus are displayed for preparation by restaurant staff. This Kitchen Order Display will be described in further detail below. The Automated Ordering System component of the RAS may also include a Payment Station, 9. The customer restaurant bills are presented for payment (by display, and with an optional printout) at the Payment Station. The bills are tabulated at the request of the customer. The Payment Station will be described in greater detail below.

The overall RMS component of the Restaurant Automation System includes a Reception Display, 10, in the reception area, 11 and a Reservation Display 10.1. At the Reception Display, customers without a reservation are permitted to enter a reservation, and perhaps to view a screen containing estimates of table wait time. At the Reservation Display, restaurant service staff may enter reservations that customers have phoned in. The Reception and Reservation Displays will be described in further detail below.

The RAS Central Service Center 31 hosts the RAS Central Service Center personnel 32 who monitor the health, or functioning and effectiveness, of various RAS equipped restaurants by analyzing data that is fed from each restaurant's RAS Compute Server. The RAS Central Server 33 maintains this consolidated information. The RAS Central Server also maintains consolidated information on frequent diners of RAS equipped restaurants in support of the Customer Personalization System. Finally, the RAS Central Server also contains a repository of music files that is downloaded to various subscribing restaurants on a rotational or trend-driven basis. Patrons using the E-Menu can then listen to these music files via streaming audio from the local restaurant RAS compute server.

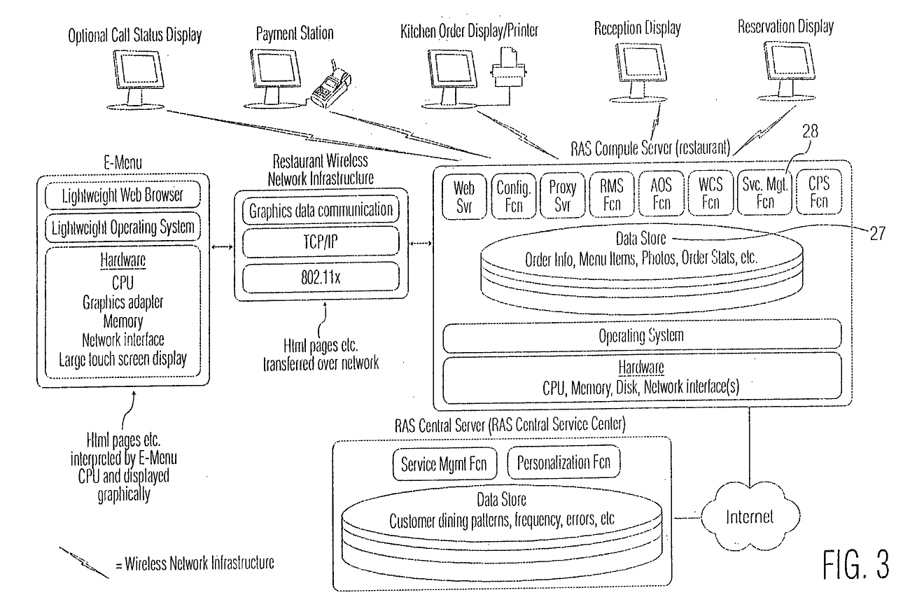

FIG. 3 illustrates an alternative software architecture for the RAS, with one basic software alternative, its components and connections to other displays in the Restaurant Automation System. FIG. 3 depicts an architecture in which the E-Menu has a Central Processing Unit (CPU). In this alternative structure, the RAS Compute Server transmits html pages and other data forms from its data stores that represent the information requested from the E-Menu. This information is transmitted over the wireless network infrastructure to the requesting E-Menu device. The E-Menu's CPU interprets these html pages (and other data forms) and converts them to a presentable graphical format that is then displayed on the E-Menu's LCD display by the graphics adapter.

New applications can be easily added onto the Restaurant Automation System compute server as new technologies are developed and/or new needs arise. It is the RAS compute server which accumulates the information regarding occupied tables and calculates expected table wait time for the Reception Display, based on orders placed, served, and phone-in reservations. It is the RAS Compute Server that communicates the orders to the Kitchen Order Display, 8, and the total costs of the order to the Payment Station, 9. The wireless communication between the RAS Server and the E-menus supports free-flowing digitalized text to all E-menus. Preferably the RAS compute server is connected to a broadband Internet service, which can provide Internet browsing on the E-menus via a Proxy Server function. Table to table gaming is also supported by the wireless network and appropriate software. All software and hardware functions in the E-Menu must be lightweight i.e., they must minimize use of memory space, processing cycles, power, etc. The E-Menu must be inexpensive enough to distribute to every diner. Only by efficiently designing software, minimizing licensing costs, and minimizing hardware costs, can the E-menu be manufactured at a feasible cost. One feature that may be of remarkable importance in the E-menu, is the ability to perform in many languages, permitting reading, ordering, gaming, and perhaps even conversing in different languages.

Note that the Figure depicts a TCP/IP and 802.11x based network. This may be implemented using a wireless Local Area Network based on 802.11x standards, or may be based on wireless cellular technology. The RAS is based on wireless networking, which may be implemented using any of a number of technologies.

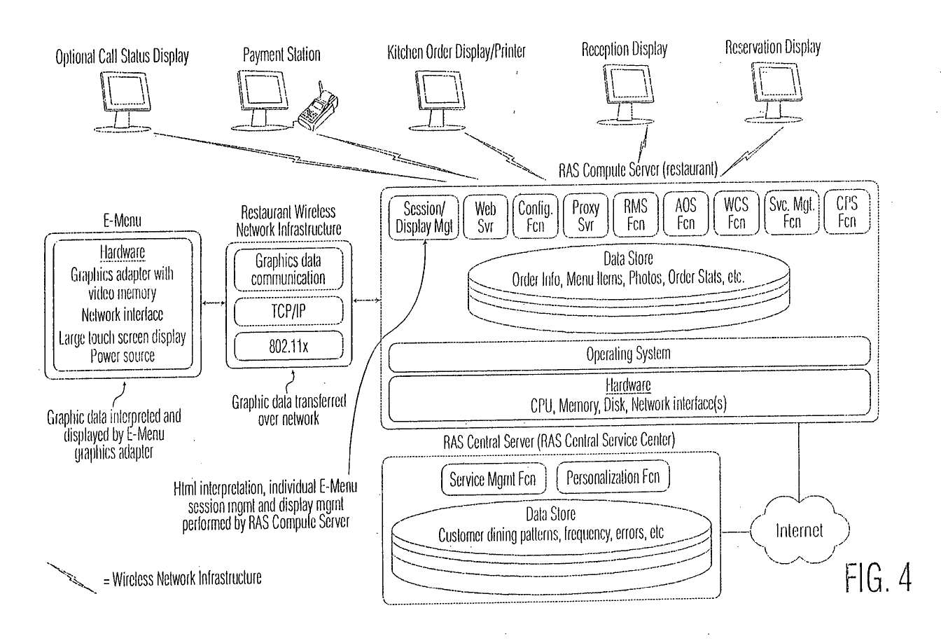

FIG. 4 illustrates a second alternative architecture for the RAS that minimizes the hardware and software requirements on the E-Menu thereby minimizing its development and production cost. In this approach, the E-Menu simply serves as an interactive display device without a Central Processing Unit (CPU). In this case, the process of interpreting html pages (and other data forms), and converting them to a presentable graphical format, is performed by the RAS Compute Server. The RAS Compute Server then transmits this pre-processed graphical data over the wireless network infrastructure to the E-Menu. The graphics adapter in the E-Menu then presents this graphical data to the E-Menu's LCD display.

The advantage of the architecture depicted in FIG. 3 lies in the fact that html pages (and other data forms) represent a relatively small amount of data that must be transmitted over the wireless network. Additionally, this is a standard methodology used in web communications today. However, the disadvantage is that a CPU is required on the E-Menu to interpret these data forms and convert them to graphical information thereby increasing its cost. The advantage of the architecture depicted in FIG. 4 lies in the fact that since the data-form-to-graphics interpretation work is already done by the RAS Compute Server, a highly functional CPU is not necessary on the E-Menu. The E-Menu becomes a simple terminal display device. However, with this E-menu configuration a great deal of graphical data must be transmitted over the wireless network infrastructure and this may result in which may affect performance. Also, the RAS Compute Server must bear the load of managing multiple E-Menu sessions and display directions. Hence, a more powerful RAS Compute Server platform would be required.

Note that the FIG. 4 also depicts a TCP/IP and 802.11x based network. This may be implemented using a wireless Local Area Network based on 802.11x standards, or may be based on wireless cellular technology. The RAS is based on wireless networking, which may be implemented using any of a number of technologies.

RAS Common Functions

There are a number of underlying functions and resources provided by the RAS that are common to the four main component systems. These common functions and resources include the data store, web server, Service Management function, and Configuration Function.

The data store may be a commercially available database, embedded database, open source code, or may be specifically developed for the RAS. The data store provides a common data repository of information that supports all the four main component systems (WCS, AOS, RMS, CPS). The data maintained in the data store on a restaurant's RAS compute server includes, but is not limited to, the following:

Menu items, descriptions, photos, prices, etc.

Hyper-links to sites advertising on E-Menus

Data on closed service calls (time to call completion, table ID, etc)

Reservation scheduling data

Marketing information such as dishes ordered, web sites visited, length of meal, number of persons per party, etc.

Error and performance information related to the restaurant's RAS system (transmitted regularly to data store on RAS Central Server).

Local music files

Feedback or query data provided by customers

A data store resident on the RAS Central Service Center Server includes, but is not limited to, the following data:

Dining pattern information collected from various RAS equipped restaurants on frequent diners such as types of meals, dining frequency, dining geography, RAS customer ID, etc.

Error and performance information across all RAS equipped restaurants

Centralized music file repository

A web server running on each restaurant's RAS Compute server can provide standard access to the information in the underlying data store through the web browser function running on E-Menus. The web browser provides the common data access mechanism for E-Menus and for the various interactive displays involved in the RAS. The software for this application-may be commercially available software, open source-code, or specifically designed for the E-Menu. Note that the web server may be publicly accessible via the Internet. Hence, a customer may access the same web site and information from their home as would be available from a restaurant E-Menu. This allows patrons to view the menu, pricing, place take-out orders, and make reservations, view wine lists, etc. prior to entering the restaurant.

A common Service Management function running on the restaurant's RAS compute server monitors the health, or functioning and effectiveness, as well as the performance status of various components of the RAS compute server and sends this data to the RAS Central Service Center Server's Service Management function. Here, the RAS Central Services Center personnel can analyze the data and take proactive remedial actions. The following lists some of the items that may be monitored by the Service Management function:

Restaurant's network utilization and performance rates, error rates, etc.

RAS compute server disk, CPU, memory utilization

Broadband link utilization

If the RAS Central Services Center personnel detect that something may impact service at a RAS equipped restaurant, they may contact the restaurant's management or may dispatch a service technician to resolve the issue.

A common Configuration Function allows restaurant management to configure various aspects of the RAS system. For example, for the AOS, the configuration function allows the restaurateur to update the menu items, descriptions, prices, photos, etc. quickly and easily. This is in contrast to traditional hard copy menus that must be reprinted when menu items or prices change. Daily specials may be changed daily electronically rather than by updating a chalkboard. For the RMS, the restaurateur may configure how long the restaurant should wait for a party that has a reservation before making their table available to other diners. The configuration function provides a simple Graphical User Interface (GUI) that allows data entry by any member of the common service staff pool.

As the Configuration Function runs on the RAS Compute server, it can be accessed from any restaurant display including the Payment Station Display or the Kitchen Order Display. The function should be password protected.

One frequently used function, the Menu Modify function of the Configuration Function, is a process that allows the restaurant management to add/change/delete items, daily specials, descriptions, photos, pricing, etc. on the menu.

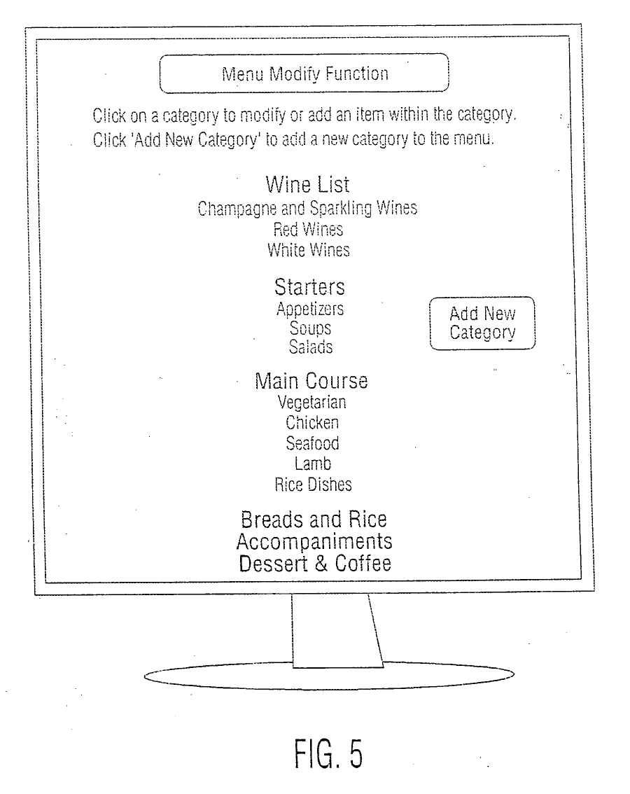

FIG. 5 depicts the main, or home, screen of the Menu Modify function. This screen allows restaurant management to select which part of the menu they want to update, or create a new category or section in the menu.

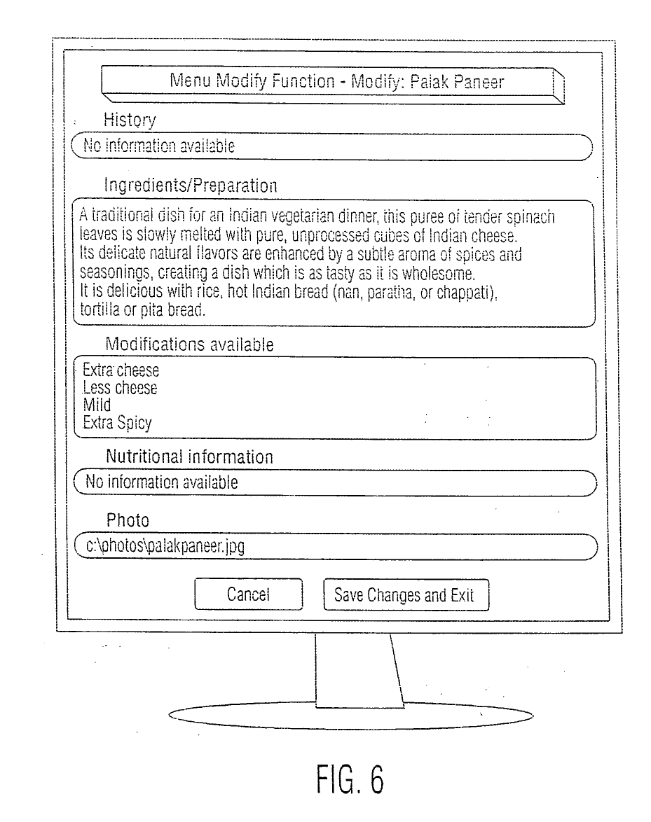

FIG. 6 depicts the Modify Screen that allows the actual update of information for a specific item in the menu. After changes are made, such as by simply typing in new information, restaurant management can save changes. The changes take effect immediately in the data store and the new information is available to diners via the E-Menu. Note, the new information may be “typed in” using a convention keyboard device attached to the display device, or by means of an onscreen touch activated keyboard.

Waiter Call System

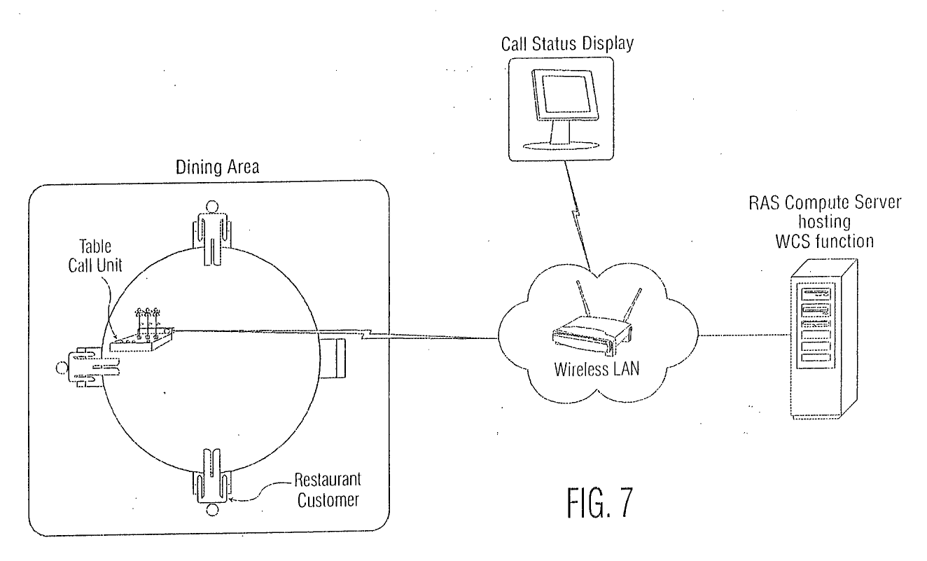

One of the four components of the preferred embodiment of the Restaurant Automation System is the Waiter Call System (WCS). The WCS provides a system by which a restaurant customer can efficiently call the attention of any member of the restaurant's service pool. The actual call process may also provide an indication of what the customer desires thereby eliminating the inefficiency of the “double-trip”. The WCS may be designed with an optional Call Status Display function that centralizes the display of all customer service requests. FIG. 7 depicts the WCS Architecture. Its components are described below.

Table Call Unit

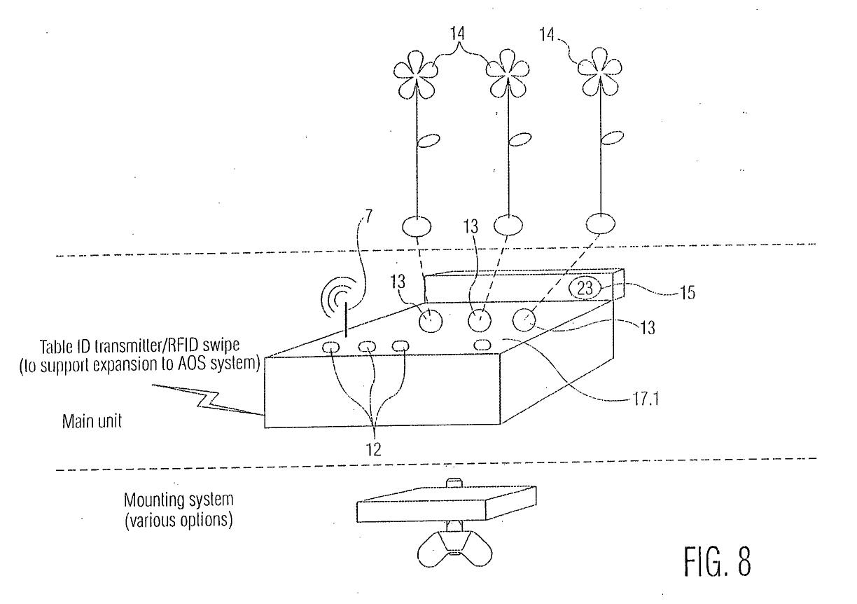

The basic unit of the Waiter Call System is the Table Call Unit (TCU). FIG. 8 depicts the Waiter Call System Table Call Unit according to a preferred embodiment of the present invention. The TCU has several buttons, 12, associated with the most frequently requested service functions. These can be interpreted to mean anything a particular restaurant determines suitable. For each button, a distinct color light or pattern is displayed in either a standard display, e.g. service call lights, 13, or an attachable decor-integrated light display such as at 14, suitable for the restaurant. For the service staff scanning the dining floor, this gives an immediate indication not only of the fact that a particular table requires service, but additionally, based on the color/pattern of the display, exactly what service is being requested. This eliminates the wasteful “double-trip” in which the waiter/waitress makes one trip to determine what the diner wants and then another trip to satisfy the request.

TABLE 1
below provides an example implementation.

| Button | Color displayed | Function |
|---|---|---|
| 1 | Orange | Service Personnel |
| | | requested for |
| | | inquiry, etc. |
| 2 | Blue | Water requested |
| 3 | White | Cash payment |
| 4 | Repeating blue pattern | Soda refill |

The WCS table unit may contain an integrated timer with display, 15. When a service button is pressed, a timer is started that displays in seconds, the amount of time elapsed until the service call is fulfilled and the timer is manually stopped with the “end call” button. This function records the call and response times, which may be stored in the Server as a quality of service gauge.

The Table Call Unit may also contain a Table ID transmitter/RFID swipe device 7 that transmits a unique table ID that is received by the Automated Ordering System's E-Menu units (described in next section). In order to prevent one table's E-Menus from receiving the table ID transmissions from another table's transmitter, the transmitters may be set to a low power thereby requiring close proximity of the E-Menu in order to establish the table ID onto the E-Menu. This function of setting a unique table ID on a table's E-Menus can alternatively be implemented by use of a Radio Frequency Identification (RFID) based means. This would allow an E-Menu to be swiped across an RFID unit that electro-magnetically affixes a unique table ID onto the E-Menu.

If the E-Menu is moved to another table, it is swiped at that table's RFID transceiver and all subsequent operations from that E-Menu are associated with the new table. If a restaurant implements both the Waiter Call System and the Automated Ordering System, this transmitter or RFID transceiver is embedded in the Table Call Unit. If only the Automated Ordering System is implemented without the Waiter Call System, then the table ID transmitter/RFID transceiver means is affixed to or embedded within the dining table. The Table ID transmitter/RFID swipe device is modular so that it may be plugged into or removed from the TCU or the table easily.

As will be discussed in the next section, a modular wireless means is also used in the TCU for restaurants that have the optional Call Status Display. This wireless means allows transmission of call request data to the RAS Compute Server (or alternatively, directly to the Call Status Display if only the WCS, and not the AOS/RAS compute server have been implemented) which then relays it to the Call Status Display(s). This wireless means is modular so that it may be easily plugged into or removed form the TCU.

Call Status Display Option

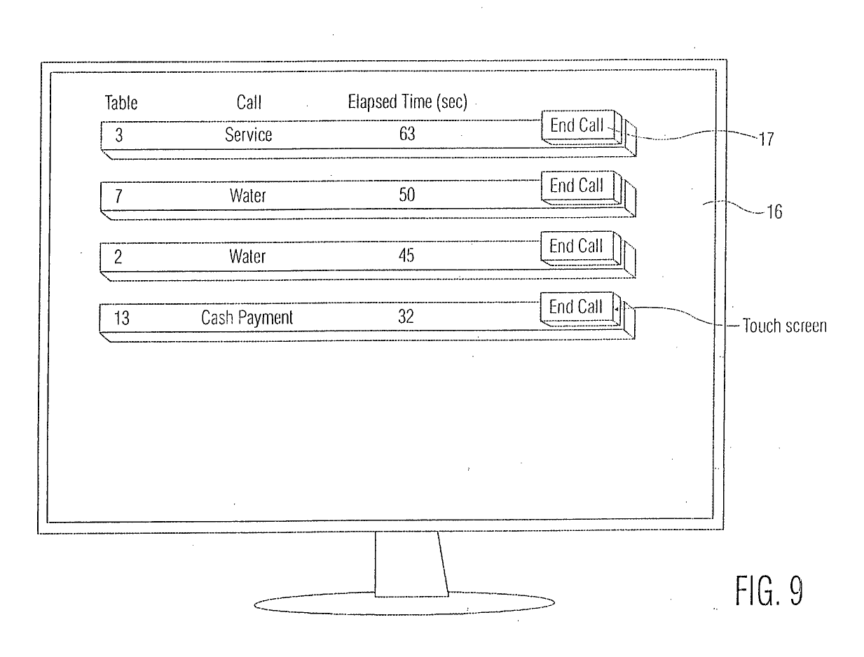

The Waiter Call System with the lighted Table Call Unit display is well suited for large, open dining areas that can be scanned easily for the Table Call Unit lights, or where there are a large number of service personnel. In restaurants that have partitioned seating areas or where the dining floor contains secluded sections, it may be difficult for service personnel to scan all areas easily and respond quickly. In such environments, it may be appropriate to supplement or substitute the lighted Table Call Unit displays with one or more Call Status Displays, such as at 16 in FIG. 9. The Call Status Display(s) could be located at a position(s) in the restaurant easily viewable by the service personnel. The RAS Compute Server-based WCS function can be monitored via the Call Status Display(s) throughout the restaurant. In this preferred embodiment the function and display provide an easily viewed Graphical User Interface (GUI), 17, that displays the service call status of all tables. Colors may be used in the display to reflect the amount of time that has elapsed since the customer request and hence, the urgency of responding. Touching the screen at a particular location, such as at “end call” may produce a particular result such as deleting the service request line from the display and entering data about the request such as type of request, table ID, time to completing request, etc. into the RAS Compute Server's data store. Pressing the end-call button 17.1 on the TCU has the same effect. Reports can then be generated from this stored data that can be used by the restaurateur to help identify service issues.

If the Call Status Display is used, it is necessary to introduce a wireless communications means within the Table Call Unit. This wireless communications link is used to communicate data related to the service request to the RAS Compute Server over the wireless network infrastructure. The RAS Compute Server then transmits this information to the Call Status Display(s).

It is also possible to implement the WCS with the TCU and a Call Status Display but without the RAS compute server. In such an implementation, pressing a service button on the TCU generates a wireless transmission to the Call Status Display directly where all service calls can be monitored. In this case, the Call Status Display has a wireless receiver, LCD touch display, memory, and intelligence to display the service calls and delete them when the “end call” button is pressed. Since there is no RAS compute server involved, the benefits of service call data collection and reporting are not available.

WCS Function

The WCS function resides on the restaurant's RAS compute server. When a table makes a service request via the Table Call Unit, the TCUs wireless interface sends the request to the WCS function. The WCS function forwards the request information (table ID, type of request, etc.) to the Call Status Display. When the service call is fulfilled and the “end call” button is pressed either on the Call Status display or on the TCU, a message is conveyed to the WCS function to remove the service call information from the Call Status Display and saves the request information in the data store for future service reporting/analysis.

WCS Process Flow

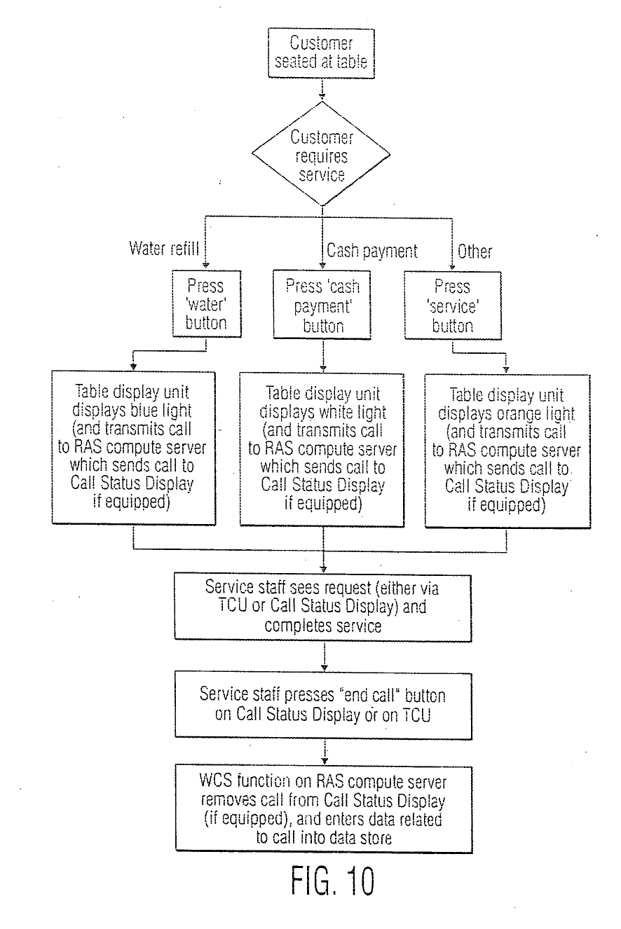

FIG. 10 depicts the process flow associated with one implementation of the Waiter Call System. As shown, when the customer requires service they may request water, cash payment, or some other designated service. The Table Call Unit may alert the service staff to complete the specific request using a pre-set color code for the type of request. The Central Call Status Display(s) can also alert the service staff to complete the request. Thereafter, the “end call” button may be pressed on the Table Call Unit and/or the Call Status Display. Data related to the call is then stored in the RAS compute server's data store for future analysis/reporting (if implemented in conjunction with the RAS compute server).

Automated Ordering System

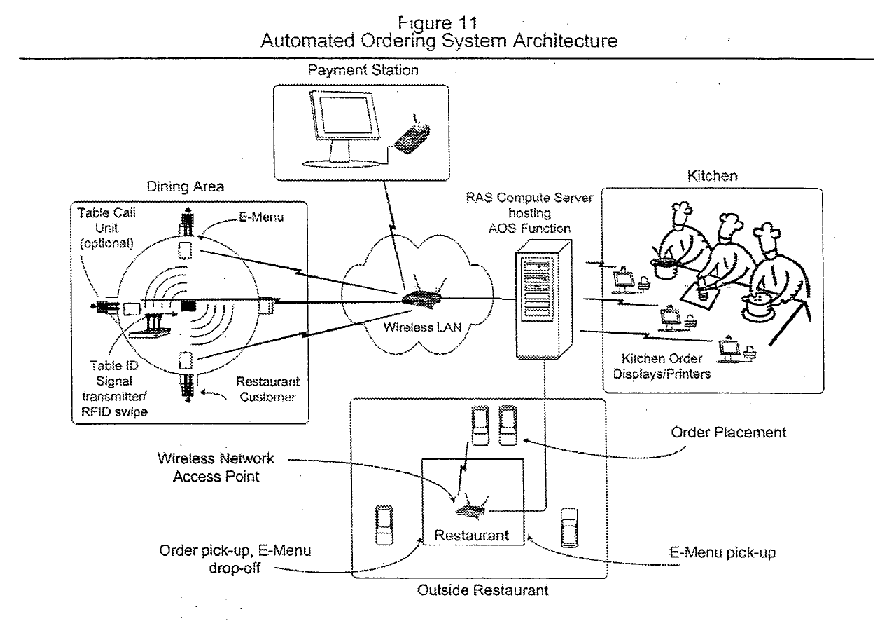

The most preferred Automated Ordering System (AOS) of the present invention consists of five main components: the E-Menu, the Table ID transmitter/RFID swipe device, Kitchen Order Display, the Payment Station, and the Automated Ordering System function, 18, residing on the RAS Compute Server. FIG. 11 depicts the Automated Ordering System architecture.

In the Automated Ordering System, the traditional hard copy menu is replaced with a hand held electronic device with a large, preferably touch activated, display on e.g., an LCD screen. This device, called an E-Menu, is a low cost electronic appliance that provides diners access to a database of rich content information residing on the RAS Compute Server. This information includes the menu, photos of menu selections, information on the restaurant, chef background, nutritional information, call status information, access to web servers, audio files, etc.

The Automated Ordering System function provides a number of advantages to the diners by carrying out various functions originally accomplished by wait staff (at their own, unregulated speed), by instantly coordinating and processing input placed by diners via the E-Menu and various interactive displays throughout the restaurant. For example, the AOS generates orders for the kitchen and displays the orders on a Kitchen Order Display. For increased efficiency, the AOS can send the entree orders to an entree kitchen order display, 26.1, near the preparation station/location for the entrees, and send the dessert orders to another kitchen order display, 26.2, near the preparation station for the desserts, and send the appetizer order to another display, 26.3, near where the appetizer will be prepared. In addition, the AOS processes billing, interacts with the Payment Station to settle bills, etc. The Automated Ordering System function may also maintain food preparation status information that can be easily viewed by the diners on the E-Menu. This may facilitate a desired order change. Wireless networking technology is used as the communications infrastructure between the various components of the Automated Ordering System.

The AOS also provides an entertainment service that includes single and multiplayer games and streaming audio that can be played on an E-Menu or on a table's speakers via the E-Menu.

The portability of the E-Menu and its capacity for wireless communication enable it to facilitate new processes for drive through ordering. There is an increasing demand for drive through service at higher-end restaurants. Such a service would allow customers to enjoy a higher food quality with a convenience that accommodates a busy lifestyle.

FIG. 11 also illustrates the AOS function for a drive-thru/pick-up restaurant operation. Such an operation requires a wireless network access point outside the restaurant/kitchen building, as shown. In addition, E-menus need to be provided to, and retrieved from, clientele. As shown, the clientele arrive in vehicles, pick up E-menus, place orders, pick-up orders, pay, and drop off E-menus, all from the vehicle. As may be well understood, the vehicles need not be a part of the system, as with restaurant pick-up form a restaurant in a large city, and vehicles may be used in relation to part of the operation, as when picnic tables are provided for dining outdoors.

In today's drive through services for fast food restaurants, there is often no menu available until the car pulls close to the ordering location. The customer must then review the menu and decide his/her order quickly in order to keep the line moving. Once the order is decided, an often awkward and unclear speaker/microphone system is used to communicate the order to the restaurant staff. This is prone to errors. Of course, the fixed menu display provides very limited, one line descriptions of the food offerings.

One of the reasons such a drive through arrangement is used for fast food restaurants and not used for finer dining establishments is that the food offering at fast food restaurants is more standard, less variable, and suitable for short one line descriptions. In contrast, offerings at finer dining establishments require more description, are less standard, and are better suited for pictures, and other forms of rich descriptive media. Therefore, the E-Menu can be used to provide the richer information and convenience required to make the drive through process more suitable for higher-end food establishments.

The overall process of using the E-Menu in a drive through scenario is fundamentally the same as for the sit-in scenario. The drive through scenario requires an order ID to identify the order/vehicle instead of the table ID. Additionally, an order placed on a drive through E-Menu would have an indication of this fact on the Kitchen Order Display so the kitchen staff can package the food accordingly. Finally, as discussed later additional means for securing/encrypting wireless communications are added to the drive through E-Menus discourage theft and use of the wireless network by non-E-Menu devices.

In the drive-thru embodiment shown, as customers drive into the restaurant's drive through lane, they are handed an E-Menu(s). Customers within the vehicle can review the food offerings, prices, descriptions, etc. and place their orders. The preferred process flow for the drive through system would allow all occupants of a vehicle to collate orders into a single order by placing one large order on a single E-Menu. This would generate a single order number by the AOS application that would be returned to the E-Menu on which the order was placed. Alternatively, each occupant may place his/her own order and have a specific order number for the order returned to the appropriate E-menu. This may be desired if separate billing is required.

Once the order is placed, it is displayed in the Kitchen Order Display(s), with an indication that it is a drive-through order, and an order is number generated by the AOS application. The remaining a process flow is much the same as for sit-in diners. Since finer dining establishments require more time for food preparation, the vehicle may park while the food is being prepared, or may remain in the drive-through lane. When the chef starts preparation on the order, he makes an indication via the Kitchen Order Display by pressing the “Prep Started” field. When the order(s) is ready, the kitchen staff may press a touch screen field on the Kitchen Order Display which sends a signal to the AOS application to update the order status to “Completed” and relay a signal to the appropriate E-Menu with an indication that the order has been prepared and is ready for pickup at the pickup window. The occupants of the vehicle may then pickup the food and provide payment at the payment window where the E-Menus may be returned. Payment can also be made at any time during this process.

As noted above, a network access point would be provided outside the facility to allow the wireless network signal to be available to the patrons in the vehicles. The wireless network and drive through E-Menus may implement a means of security that would render the E-Menu useless outside of the restaurant's premises. Additionally, the wireless access may use a security means to ensure that other wireless devices cannot use the network services of the restaurant.

E-Menu

The E-Menu is one of the core components of the Automated Ordering System. The E-Menu is a low-cost, large display device, preferably touch activated, with built-in wireless networking and rechargeable/replaceable power source. The E-Menu serves as the diner's primary interface to the Automated Ordering System.

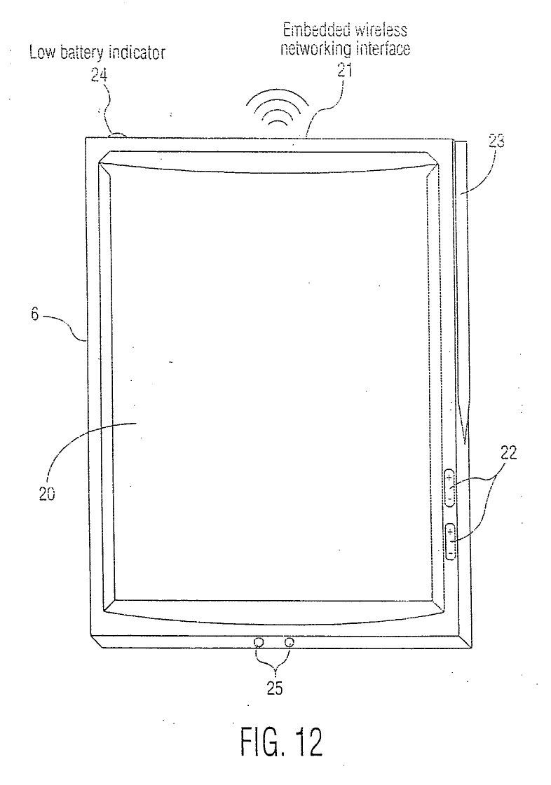

FIG. 12 depicts one possible implementation of the E-Menu, 6, with the large interactive touch screen display, 20, and embedded wireless networking interface, 21. Preferably the E-menu/also has brightness/contrast controls, 22, readily accessible by the customer/diner, and an optional pointing device, 23, which may be used on the touch screen, 20. The E-menu has a low battery indicator, 24 and may have battery-charging contacts, 25. However, in another embodiment of the E-menu, the battery is conductively recharged. In still another embodiment, the battery is replaceable but not rechargeable. New battery designs include batteries, which are extremely flat, including batteries that are printed on paper, giving them the perfect configuration for inclusion in the E-menu.

The E-Menu may comprise the following hardware (specifics are subject to change depending on the method of implementation):

Large touch screen display (b/w or color)

video-display adapter

Memory (either RAM or video memory onboard video adapter depending on implementation)

Rechargeable or replaceable power source, such as a battery

Low battery indicator

Battery charging interface/contacts, or means, such as a slotted opening for replacing the battery

Integrated wireless communication interface

Brightness/contrast controls

Pointing device

An interface (not illustrated) that allows for firmware upgrades—this may be performed via wireless network interface

May contain a Central Processing Unit (CPU) depending on implementation

Reset button

RFID receiver or electromagnetic means of receiving table ID

Speaker or speakers

Audio output interface

There are two primary methods of implementation envisioned for the E-Menu as described in the discussion on the software architecture alternatives in relation to FIGS. 1-4. First, the E-Menu may contain a CPU. In this case, the E-Menu may run a light operating system that minimally serves the purpose of the E-Menu device. This may be a commercially available operating systems such as Microsoft's Pocket PC®, 3Com's Palm OS®, a commercially available embedded operating system, open source code, or may be specifically developed for the E-Menu. The E-Menu may also run a web browser function that is also a light function, which communicates with the Automated Ordering System server function via the RAS compute server's web server over a wireless network and a standard protocol such as HTTP and graphically presents html page information from the Automated Ordering System function to the diner.

The E-Menu may alternatively be implemented as a light “display device” that has no CPU or noteworthy operating system. In this case, the E-Menu's main components would consist of a wireless network interface, touch sensitive display, such as an LCD display, and a video adapter. In this implementation, the RAS Compute Server would assume the responsibility of interpreting html and other data forms into a graphical file that would be sent over the wireless network to the E-Menu that would then simply display the graphics file to the diner. For a discussion of the advantages and disadvantages of each implementation approach, see the discussion on software architecture alternatives in relation to FIGS. 1-4.

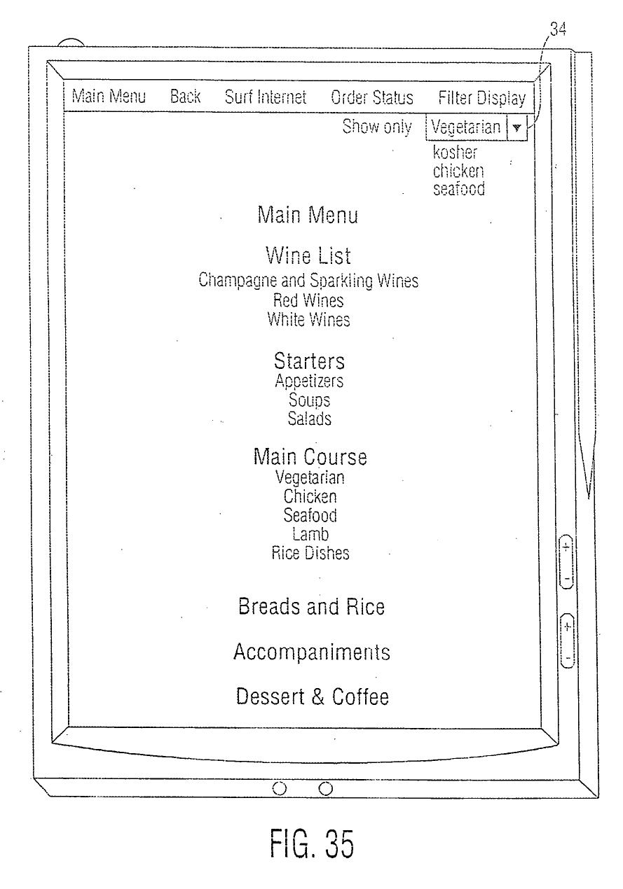

The main intelligence of the Automated Ordering System resides in the Automated Ordering System function running on the RAS Compute Server. The E-Menu simply provides a platform by which customers access the Automated Ordering System function. The Automated Ordering System function allows diners to categorically (e.g., by vegetarian, chicken only, seafood only, price range, etc.) filter the display of menu items. The E-Menu presents and displays this information to the customer and allows the customer to navigate through the Automated Ordering System functions. The Filter Display function accessed from the E-Menu is displayed in FIG. 35.

The AOS function also serves as a powerful search engine for items such as large wine lists that may contain thousands of wines. This search/filter function may allow a patron to search by wine category or may make wine suggestions for particular meal selections.

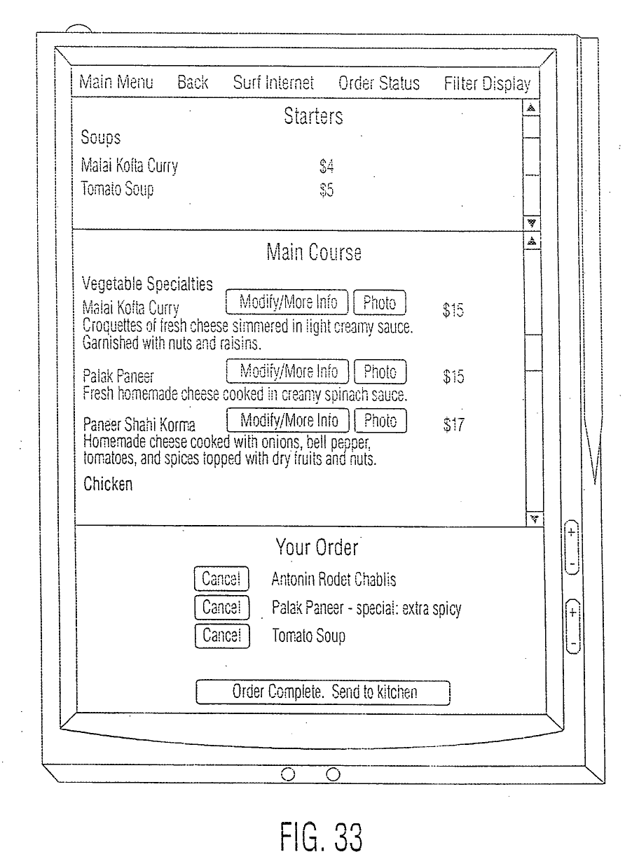

The E-Menu provides flexible viewing options that for example, allow two meal courses, or sub-menus, to be viewed at once by dividing the screen into two sections. This allows easy comparison of, for example, appetizer items and main course items. FIG. 33 depicts this function.

In another implementation, the E-Menu may be realized by a bi-fold or tri-fold device as depicted in FIGS. 36 & 38. This would also extend the options for display by allowing more courses or windows to be displayed simultaneously.

The price of the E-Menu must be kept minimal and its performance must be maximized for its cost. To this end, the E-menu may be provided with an automatic on/off function to conserve power, and e.g., time saving auto-sensing and adjustment of brightness and contrast. However, it is preferred that extraneous functionality and processing is eliminated from the E-Menu thereby making it an appliance type of device.

In a preferred embodiment, each E-Menu contains a means of receiving a Table ID from a Table ID transmitter/RFID swipe device that is either embedded in the Waiter Call System's Table Call Unit as previously described or embedded/affixed to the table as an independent device. This Table ID is then sent along with the individual's order in the transmission to the AOS function where it is collated with other orders from the table. If an E-Menu is handed to someone else at another table, it can pick up the new table's ID signal via proximity to the signal source or via swiping across an RFID transceiver.

The E-Menu demonstrates physical tolerances appropriate for the environment in which it is used. It shall withstand hot and cold liquid spills, vibrations, drops, food spills, etc. The E-Menu should contain no protruding buttons, ports, holes, crevices, etc. into which food or liquid may enter or become lodged. The E-Menu should display a smooth continuous surface. The E-Menu provides a display brightness and contrast adjustment control to facilitate viewing in dark restaurants or in well lit or street side facilities. The E-Menu interface and selection buttons are sized appropriately for use by human fingers. However, a touch screen pointing device, 23, is also provided as an attachment on the E-Menu for those who prefer this option.

Preferably, the E-menu should contain no protruding buttons, ports, holes, crevices, etc. into which food or liquid may enter or become lodged. The E-menu should display a smooth continuous surface.

One of the primary concerns of the E-Menu is that it look and feel like a traditional hard-copy menu. The E-Menu provides a simple, flowing interactive process that facilitates its use and adoption. The size, user interface, and other human interface characteristics are designed to serve this end.

In fact, the new foldable LCD screen would assist in creating an E-menu that, at first glance looks like a hard copy menu, but contains many layers of information. Foldable color LCD displays have been introduced by a number of manufacturers. Most use plastic polymer semiconductors instead of silicon. Toshiba and NEC/Samsung have introduced foldable PC monitors. The NEC/Samsung model has an acrylic screen and a flexible frame. Surprisingly, the cost of the foldable LCD monitors is about the same as for the older flat LCD screens. Samsung was the first to introduce foldable LCD screens. Their 8.4-inch monochrome display which was showcased at the Korea e-book industry tradeshow in April 2002. Unlike NEC-Mitsubishi's collapsible offerings that are targeted at desktop users, Samsung's Black and White monitor is meant as a display for electronic books. In light of its niche application, the 8.4-inch screen uses Cholesteric LCD technology a feature that allows the monitor to retain images even without a power supply. Though this might be sufficient for certain restaurant menus, many restaurants will want full color menus.

For those customers that prefer a traditional dining process, the E-Menu can be used as a traditional menu for the purpose of viewing items, descriptions, etc. For order placement, the customer may request that a member of the service staff place the order via an E-Menu on his behalf. The bill payment process can also be handed to the service staff for administration. Thus, the AOS accommodates diners who want to leverage the benefits of the automations system and gracefully accommodates diners who prefer a more traditional dining process.

At the same time, the E-Menu provides functions that cannot be provided by a traditional hard-copy menu. For example, the E-Menu allows diners to view photos of the menu items, with the specific presentation of the restaurant, and a video of its preparation. The E-menu also allows for flexible billing options, provides background information on the chef, serves as an advertising platform, etc. These functions are integrated into the E-Menu user interface in a manner that is non-intrusive to its core function of placing food orders and yet, are easily accessible when desired. Each diner is thus simultaneously provided with a wealth of information, and the ability to place an order. This point is in contrast to other proposals that require multiple diners at a table to sequentially interact with a table based ordering system that is not menu-like in its approach but rather, bulky and computer-like. Additionally, these systems require the individual diners at the table to wait for their turn to view the menu information and place orders.

Table ID Transmitter/RFID Swipe Device

The Table ID transmitter/RFID swipe device interacts with the E-Menu by assigning a table ID to the E-Menu. This may be achieved via electronic, electromagnetic, radio frequency, or other means. If the restaurant is equipped with the Waiter Call System, then the Table ID transmitter/RFID swipe device may be embedded within the Table Call-Unit. If the restaurant has not subscribed to the Waiter Call System, the Table ID transmitter/RFID swipe device may be embedded/affixed to the table itself.

The physical distance required between the E-Menu and the Table ID transmitter/RFID swipe device in order to effect setting of the table ID on the E-Menu must be relatively small. This ensures that the table ID will not be picked up by E-Menus at other tables.

Whether a proximity based transmission is used or a swipe device will depend to some extent on the table layout of the restaurant. Table proximity and positioning will be factors in this decision.

The Table ID transmitter/RFID swipe device is preferably a modular unit that can be plugged into or removed from the TCU. It may also be plugged into or removed from a table base unit that is affixed to or embedded within a table. This allows easy transition for restaurants that have subscribed to the AOS and want to add the WCS, or for restaurants that want to change their tables.

Kitchen Order Display

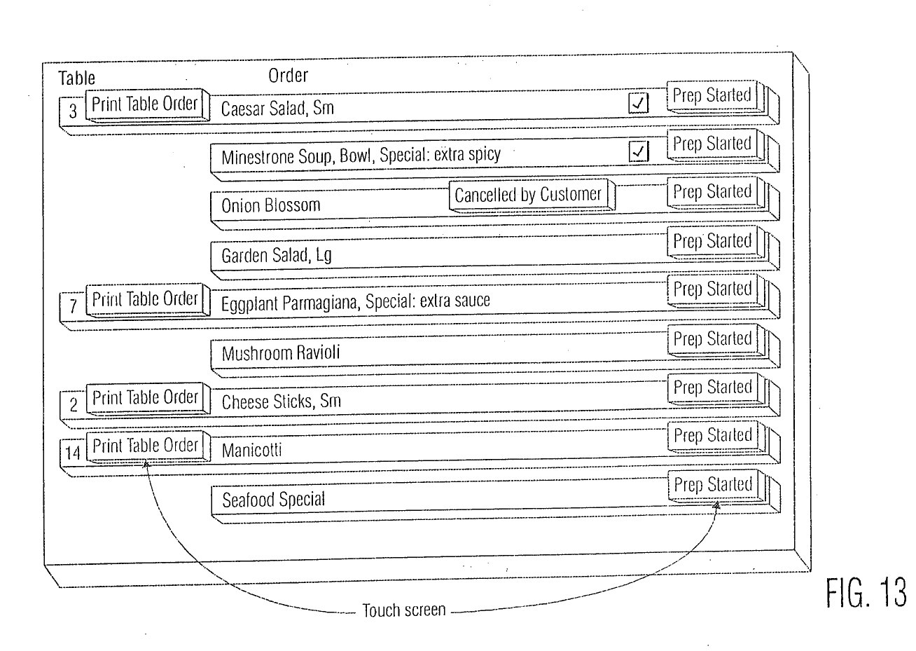

The Kitchen Order Display receives confirmed orders from the E-menus, via the server and the AOS function. The AOS function transmits confirmed orders along with the associated table ID to the Kitchen Order Display for the kitchen staff to view. Based on the floor plan and/or size of the kitchen, there may be more than one Kitchen Order Display. Additionally, in larger restaurants, separate kitchen order displays may be provided for different course, as described above. FIG. 13 illustrates an order screen such as would be displayed on a single Kitchen Order Display, 26.

Because many orders may arrive in a short time during busy periods, the Kitchen Order Display may be implemented using a display that is longer in height than in width thereby allowing a greater number of orders to be simultaneously displayed. A printer may be attached to the Kitchen Order Display via a cable or wireless means.

The AOS function manages how orders are displayed. For example, when individual orders start arriving from a table for a particular meal course in a short time window, the AOS function attempts to collate them on the Kitchen Order Display. If a late order arrives from the same table, the AOS will attempt to place the order at the end of that table's order on the display and will flash the order in a distinct color. The AOS function may remove from the display the oldest orders, for which preparation has started.

When the chef starts preparation for an individual order, he may press the “Prep Started” button to indicate to the. AOS function that it is now too late for the customer to change/cancel the order. This information will be displayed to the customer on his E-Menu by accessing the “Order Status” function on the E-Menu. Until the chef presses the “Prep Started” button, the customer may access his order from the E-Menu and change/cancel the order. This change will be reflected by the AOS function on the Kitchen Order Display. This implementation provides a user-driven “pull” based status information method, as the patron must actively check the preparation status using the E-Menu.

In an alternate implementation, an E-Menu may be mounted vertically at the side of a table when not in use. The display may be visible to the diners. When the chef presses the “Prep Started” button for a specific dish from a particular table, a signal is sent to the AOS function. The AOS function may in turn send a signal to the table's mounted E-Menu with a message indicating that preparation has started for a specific dish ordered from the table. This may be repeated for each dish ordered by the table. This implementation provides a pro-active “push” status information method.

The chef may also choose to print a particular order by pressing the “Print Table Order” button.

Payment Station

The Automated Ordering System function also provides a billing function that takes a table's order information, generates a bill, and sends the information to a Payment Station where diners can make payment.

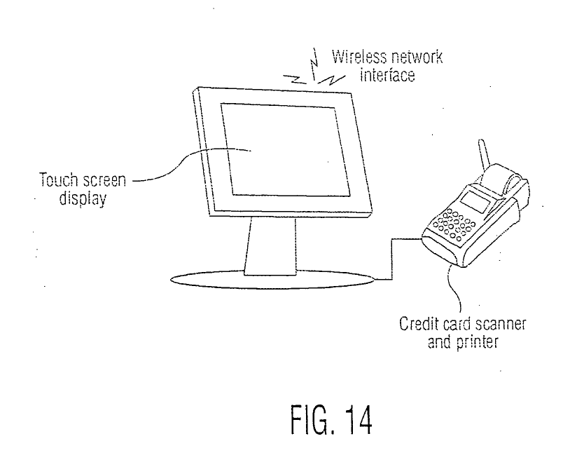

The Payment Station may be provided with a touch screen interface through which diners can identify their table, print a bill, and make credit-card payment. The Payment Station may consist of a processor with a wireless network interface and a Payment Station Display, such as the touch screen monitor depicted in FIG. 14. Alternatively, the Payment Station may be a light “display client” with a video adapter, large touch sensitive screen, and wireless network interface. The Payment Station may also provide a credit card swipe device with a built-in printer and electronic signature capture means so the restaurant does not need to physically track signed receipts.

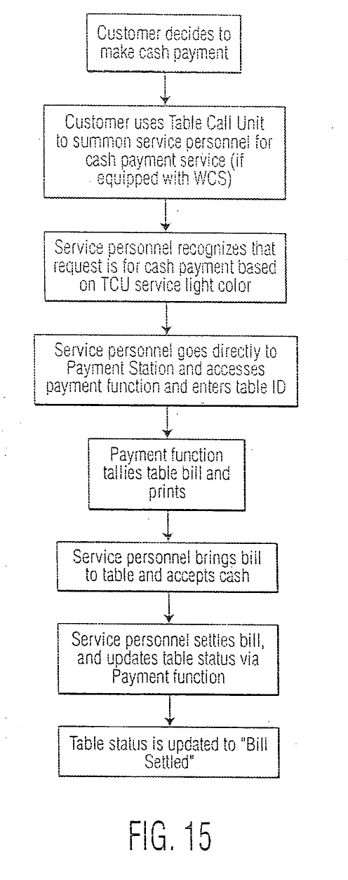

Cash payment can be made to a member of the service staff. A cash payment request button may be one of the buttons on the Table Call Unit of the Waiter Call System. (The traditional method of calling a waiter's attention must be used if the WCS has not been implemented). In addition, a member of the restaurant common service pool may access a password protected “cash payment” function accessible on the Payment Station display. After depositing the cash and removing change, the service personnel may then indicate that the table's bill has been settled via the Payment Station's touch screen. Alternatively, a specific cash Payment Station may be used that is located in an area not accessible by customers. Once payment is made, this information is fed back to the AOS function that then updates the table status in other functions such as the Reception Management System discussed later. FIG. 15 depicts the process flow associated with cash payment.

A Table Payment Status screen can be accessed via a password protected function on the Payment Station display (or a dedicated Payment Station only accessible to restaurant staff). The Table Payment Status screen, accessible at the Payment Station 9 displays the following payment states associated with tables:

Payment pending

Partial payment made (in cases of multiple bills per table

Payment made and subsequent order

Payment settled

Display colors may be associated with each state to provide a quick assessment of the payment state of occupied tables. For example, Payment Pending may be indicated in red while Payment Settled may be indicated in green.

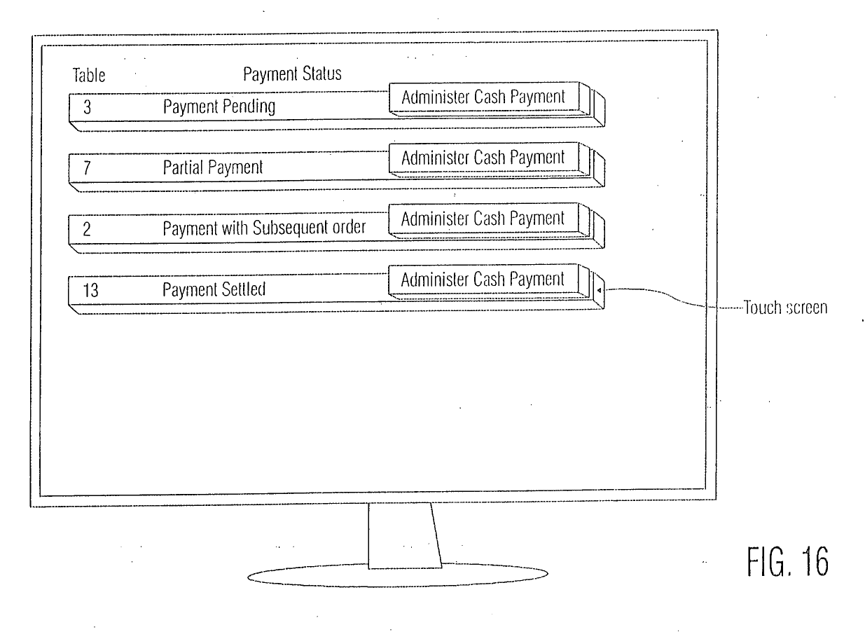

The Table Payment Status Screen is depicted in FIG. 16.

Bill Payment can also be made in the traditional manner by a member of the restaurant's common service pool at the request of the customer if so desired. In this case, the customer can call the service pool via the Table Call Unit (if equipped) and then give his credit card or cash for the service personnel to administer the payment process.

The number of Payment Stations at a restaurant will depend on the establishment's floor space, situational scenario, cost, etc. At minimum, a single Payment Station is required. However, each table could have its own Payment Station.

AOS Function

The AOS function coordinates the interaction between E-Menus, the Kitchen Order Display(s), and Payment Station(s), and provides the ability to “order” games and music to a table, and suggest complementary products and/or services.

The Automated Ordering System function sits atop a data store, 27 in FIGS. 3 and 4, and accesses data that is related to its function. The AOS function maintains active data related to all aspects of a table's dining status from the point a party arrives at a table to the point that all bills have been settled and the party leaves. The AOS function also accesses and presents less dynamic information in the data store such as menu items, photos, streaming video clips of meal preparation, chef background, etc.

The Automated Ordering System application provides functions available to the diner that may be accessed via the E-Menu. Diners can place orders via the E-Menu. The Automated Ordering System application maintains a record of items ordered by individuals and by the table as a whole and also maintains billing information according to the desired billing policy for the table. The Automated Ordering System application also makes status information on food preparation input by the cooking staff available to diners. Diners can also update, cancel, or change orders after they are placed providing a real-time degree of ordering flexibility.

The AOS also allows data from the data store to be requested and presented in certain ways. For example, a Filter Display function accessible from the E-Menu allows the menu data to be filtered based on specific criteria such as vegetarian, kosher, chicken only, by price range, etc. This function is depicted in FIG. 35. Additionally, the AOS allows searching or filtering of such large listings of items that it would be otherwise untenable. For example, large wine or cigar lists could be searched for specific criteria such as sparkling, red wine, white wine, California, French, by cost, etc.

As an extension to the filtering and searching functionality, the AOS function adds a degree of programmable intelligence by providing a suggestive selling service. This service provides suggestions such as wines or cigars in response to selected meal courses. These suggestions may be input by the restaurateur via the common configuration function.

The AOS function allows diners to provide written comments or input/questions via the E-Menu by writing on the E-Menu with a stylus or by using a soft keyboard. This data is sent to a staff member via the server, or, if feedback information, is stored in the data store of the RAS compute server.

The RAS compute server stores a set of audio files that may be requested via the E-Menu. The E-Menu may provide an Entertainment screen from which users may select provide an Entertainment screen from which users may select from various categories of music styles or games. Individual music files may be selected or, pre-defined “moods” or styles may be selected in which case, a series of audio files are continuously streamed to the E-Menu which may be mounted on the table for the duration of the meal or until turned off. The audio files may be played via the speakers built-in the E-menu or, may be output through an audio output port on the E-menu, to speakers on the table. The volume of each table's speakers would be limited so not to disturb adjacent tables.

The AOS function also provides a tip calculator that calculates the suggested tip for a given meal. Since one of the main objectives of the RAS is to lower operational costs for the restaurateur, these savings can be passed onto the consumer by way of lower suggested tips e.g., 10%. These lower tips would not adversely affect the service staff as their base pay may be increased by the restaurant as a result of there being fewer service personnel, and a greater number of diners.

The AOS function provides a currency conversion function that allows users to display prices in other currencies or, in both US and foreign currency. Currency data may be downloaded daily from, e.g., the RAS Central Server, to each subscribing restaurant's RAS compute server. This feature may be especially useful in areas with concentrations of tourists.

An automated billing process is incorporated into the Automated Ordering System. Automated billing allows a party to pay its bill(s) at any time during the meal. Customers do not need to wait for the check or for anyone to swipe credit cards and return, etc. This allows customers to leave immediately after completing their meal if they wish.

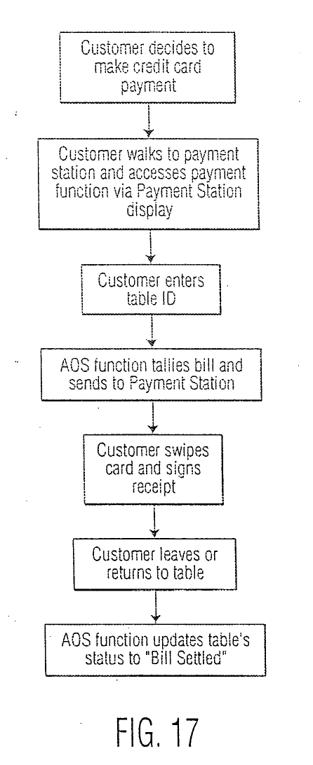

When a diner decides to pay the bill, he/she makes an indication on the E-Menu (or walks to an Payment station and enters his/her table number on the user interface). This request is sent to the Automated Ordering System function that totals the table's bill according to the billing policy for the table and sends this information to the Payment Stations. FIG. 17 depicts the Process Flow associated with a diner making a credit card payment for the table.

Various billing policies may be implemented in which a single or a number of separate bills per table may be requested. The default operation assumes that there will be a single bill associated with the table order. No action needs to be performed by any diner to establish this billing policy that reflects the vast majority of billing situations. In the exceptional case that individuals at a table want a separate bill for their own orders (as for some business meals in which individual receipts are required for expense purposes), each diner may interact with an option available on the AOS function via the E-Menu that, at order confirmation, allows the diner to associate the order with a distinct bill. The Automated Ordering System function keeps track of the various individual orders from the table and associates an identifier with each individual order along with the table that it comes from forming a table/individual order ID (e.g., 4b represents an order from individual b, at table 4). When the AOS Application sends a confirmation of the individual order back to the E-Menu, the table/individual identifier is also sent. When an individual diner picks up an E-Menu and appends to his/her order (e.g. dessert/coffee), the Automated Ordering System Application may ask the diner for the table/individual ID to which to append to. In case the individual has forgotten the ID, he/she may request that the AOS Application display all orders from the table from which he/she may then select his/her order to append to. Hence, the entire process works as it does for simple collective table billing, but may have one greater degree of resolution (introduction of the individual identifier).

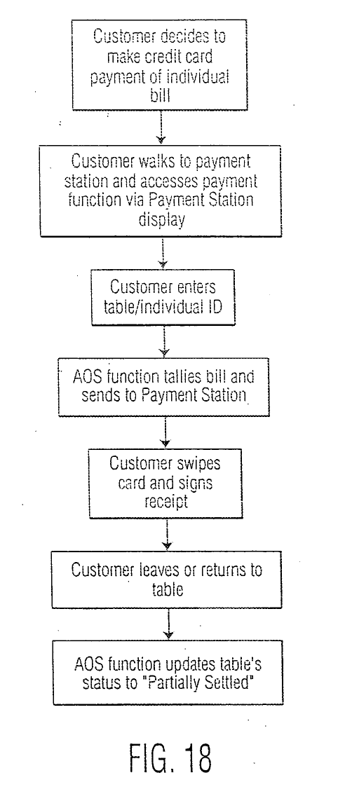

FIG. 18 depicts the process flow for tables involving individual billing. For tables at which at least one diner has requested an individual bill, payment is handled by using the table/individual ID. The individual may pick up an E-Menu and send a request to the AOS Application that his/her bill be tallied based on the table/individual ID (or he/she may walk up to a Payment Station and make the same request). The diner may then go to the Payment Station, review his/her bill, and make payment. At the Payment Station, the diners can pay their bills via credit card and can print a receipt.

It should be noted that the restaurant staff may provide adjustments to a bill. For instance, a printout of a-complementary order of after-dinner drinks may appear on the bill. In another example, a discount may be applied to a bill, to illustrate to the diner the benefits of a particular dining program. In order to apply the adjustment, a member of the restaurant staff, using an enabling pass-code for bill adjustments, may apply the adjustment to the bill using another E-menu, or the Reservation Display, or other access to the server, or directly to the payment station.

The restaurant staff is made aware that payment has been made for a table. This notification is reflected on the Table Payment Status screen on a Payment Station Display, which can display the payment status of all tables. Access to this screen may be password protected or it may be physically accessible only by restaurant staff. Colors could be used to reflect the payment status of each table. The Table Payment Status screen is depicted in FIG. 16.

The Automated Ordering System allows diners to place orders after payment has been made and alerts the restaurant staff that billing will be made for additional items. This accommodates diners that change their minds after payment and decide to have, for example, dessert or coffee. Diners will need to make another payment for these additional items. Placing an order after payment for the table (or individual) payment has been made changes the payment status of the table to, i.e. “Payment with Subsequent Order”.

AOS Process Flow

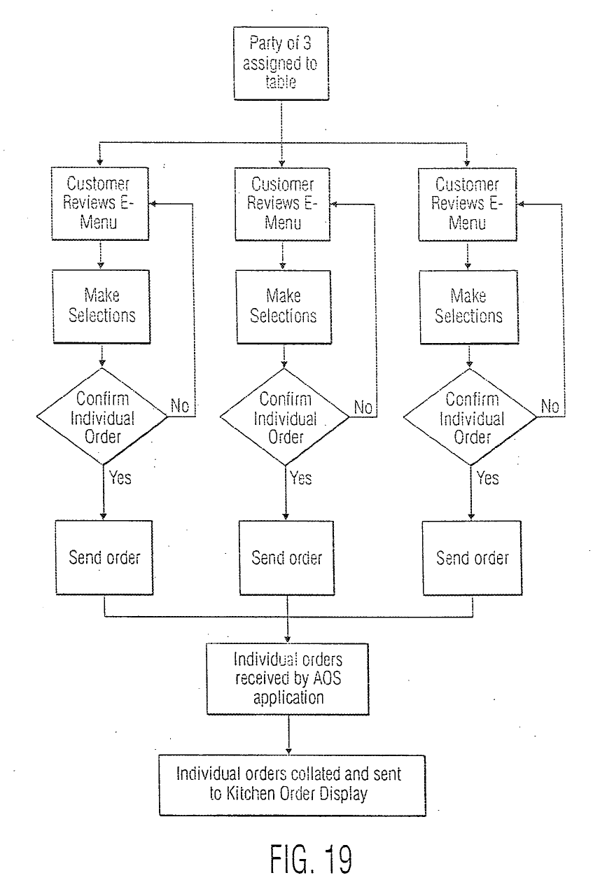

FIG. 19 depicts a simplified process flow for a party of three ordering a meal in a professional oriented restaurant where it is assumed that diners can order quickly and easily. There are a number of ways to address the concept of confirming the table order. First, there may be no confirmation (as in FIG. 19). As each diner at a table sends his/her individual confirmed order, it is received by the AOS Application on the RAS Compute Server and subsequently displayed on the Kitchen Order Display. As each individual order is received, it is correlated with other orders from that table and displayed collectively on the Kitchen Order Display. This method works well in environments that cater to professional diners who can responsibly place and confirm their individual orders within a focused time frame so that all individual orders are displayed in the kitchen at approximately the same time.

In a preferred embodiment, the E-menus may be provided with a means to disable the “sent order” function. This would be advantageous in the instance when a parent wants to order for a child and thereby prevent any erroneous orders from the child menu. This could be accomplished by a disable button on the E-menu, which could be activated by the waiter, seater, or parent. Alternative means could comprise a password protected disable function. There are many ways of accomplishing this disabling of the order send function, which will be known to those skilled in the art

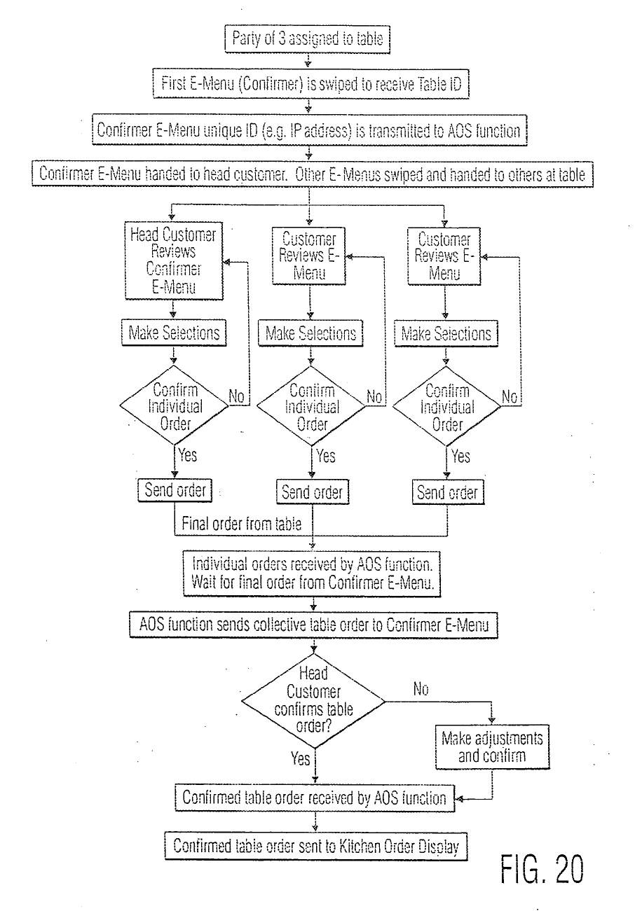

FIG. 20 depicts an alternative approach that involves designating a single E-Menu at a table as the “confirmer” E-Menu. This may be the first E-Menu swiped at the Table ID signal transmitter/RFID swipe device. A unique E-Menu ID is then transmitted to the AOS function identifying it as the “confirmer” E-Menu for the table. This E-Menu can then be handed to the table's “head” diner (the one responsible for payment, or based on some other criteria). After all individuals place their confirmed orders with the RAS Compute Server's AOS function (with the “head” diner's order being the final one and indicating that all individual orders have been placed), the AOS function sends the entire table order to the table's “confirmer” E-Menu for final confirmation of the table order. This method is suitable for family oriented restaurants where a parent's final authorization/confirmation is required before an order is accepted and sent to the Kitchen Order Display. If changes need to be made by the “head” diner (e.g., deletion of multiple ice cream orders), he may do so and then send the final approved table order.

An alternative for the family restaurant involves providing a means of disabling the “send order” function temporarily on certain menus—perhaps the ones given to children. Hence, the children are granted all E-Menu functionality but cannot send confirmed orders. It is the parent's responsibility to collect and send confirmed table orders. Finally, a simple approach to family restaurants involves not providing E-Menus to children at all.

Reception Management System

The Reception Management System (RMS) functionally sits atop the Automated Ordering System. The RMS function uses input from the Reservation and Reception displays and leverages data from the AOS function to generate estimates of table wait times and presents these wait times to arriving customers. Arriving customers can then decide if they want to wait for a table or leave. If they decide to wait for a table, the RMS function allows them to enter their names into electronically displayed queues via the Reception Display. The RMS function also interacts with a Reservation Display that accepts phone-in reservations and coordinates these reservations with table requests made via the Reception Display.

The RMS function uses table request inputs from “walk-in” customers and reservation inputs, and uses AOS table state information to determine table allocation. Once a table is available, the RMS function may utilize various methods of calling waiting customers. The RMS may optionally implement a mapping application that highlights available tables on a restaurant map and allows customers to seat themselves. This mapping application also depicts the restaurant layout, identifies tables and booths, table numbers, etc. so that walk-in customers can specify preference for a particular table.

The Reception Management System function, 28 in FIGS. 3 and 4, also runs on the RAS Compute Server that hosts the Automated Ordering System function

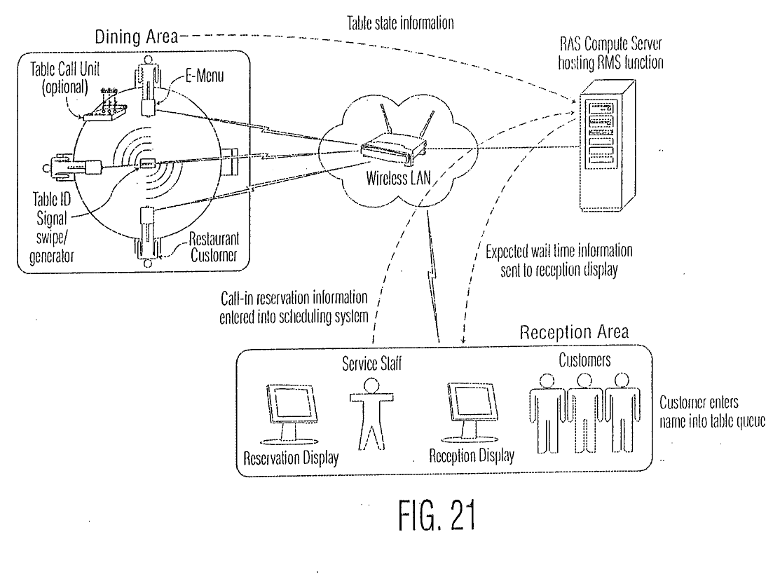

FIG. 21 depicts the Reception Management System architecture.

Reception Display

The Reception Display is located in the restaurant's reception area. It is the primary point of interaction for customers arriving at a full restaurant. The Reception Display consists of a large touch screen display and a wireless communications interface. It may also contain a sound card and a speaker.

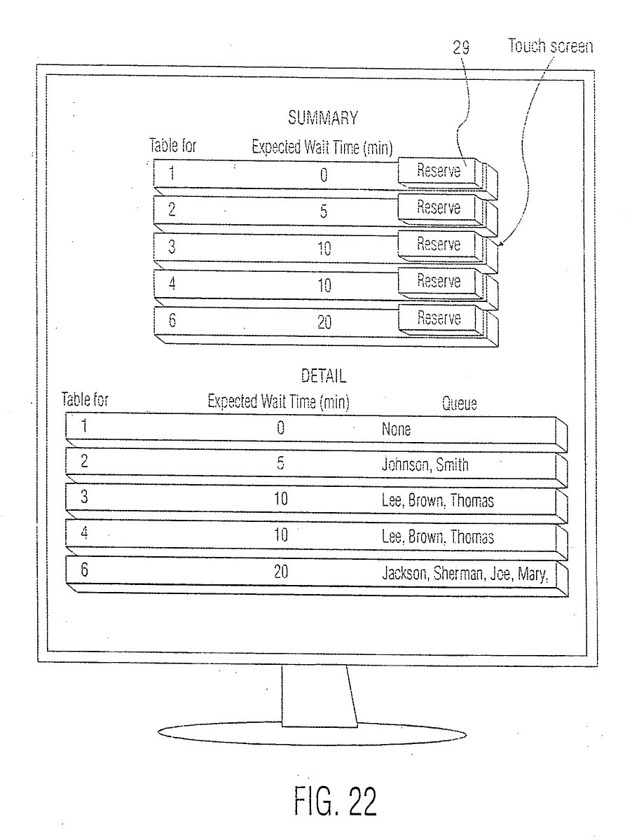

FIG. 22 depicts the Table Wait Time Summary screen provided to customers at the Reception Display. This preferred Reception Display uses colors to reflect expected wait times. For example, red may be associated with tables with the longest wait times and green may be associated with those with the shortest wait times. The summary screen provides, at a glance, the expected wait times associated with tables of various sizes. This wait time information is based on data from the AOS active table state information as described below (in RMS Function section).

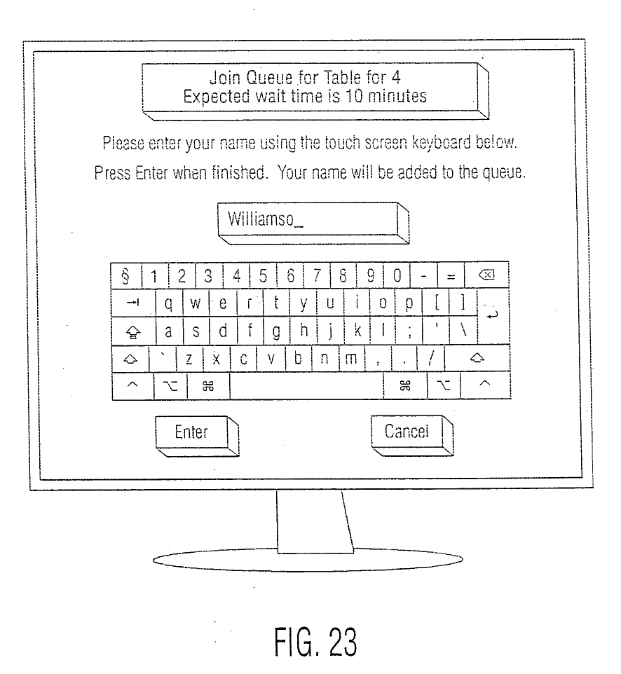

If a potential customer decides he/she wants to wait for a table, he can press the “reserve” button, 29 in FIG. 22, and bring up the Reception Display's Join Queue screen depicted in FIG. 23, and enter his/her name as indicated. The Reception Display provides a “soft keyboard” through which customers may enter name information into the queue.

Reservation Display

Many restaurants have existing systems that allow for call-in reservations or manually handle call-in reservations via paper schedule. The Reception Management System provides a dedicated display interface that allows restaurant staff to accept call-in reservations and enter them into a graphical scheduling interface.

The Reservation Display is accessible to the restaurant staff who receive phone-in reservations. The Reservation Display consists of a touch sensitive display and a wireless communications interface.

The Reservation Display shows the same information that is shown on the Reception Display and additionally provides access to a scheduling function that allows the staff to enter reservations that have been phoned-in. This call-in reservation information is stored in the RMS data store on the RAS compute server. When new customers arrive and interface with the Reception Display, the RMS incorporates call-in reservation information into its scheduling and table assignments by blocking off tables during the times for which they are reserved. If the party with the reservation does not show up in a prescribed time frame, the RMS function automatically releases the table for availability.

Information from the Reception Display is useful to the restaurant reservation staff because it provides data on the short-term availability of tables for those phone-ins that request relatively immediate reservations.

RMS Function

The RMS function resides on the RAS Compute server uses the AOS function's data store of active table state data. For example, the RMS function uses the following information from the AOS function to determine the expected wait time for an occupied table to clear.

1. Number of persons at table

2. Appetizers ordered?

3. Main course ordered?

4. Deserts ordered?

5. Bill requested?

6. Bill payment status

The RMS function considers this information and then may add a factor for the time needed to clean and prepare the table for the next party.

The RMS function is primarily a scheduling system. The RMS system receives input from the Reservation Display at which restaurant staff input reservation requests from customers who call in advance. These call-in reservations block off windows of time for tables of a specific size in the restaurant's schedule. The RMS function also receives input from the Reception Display at which customers without reservations make immediate requests for a table of a specific size. The RMS function uses these inputs, scheduling algorithms, and the AOS function's table state information to estimate wait times for tables. The RMS functions algorithms are intelligent enough to assign a table for 4 to a party of 2 or 3, a table for 6 to a party of 4 or 5, and so on based on current table utilization rate rates.

These estimated wait times are displayed on the Reception Display for entering customers. Immediate table request made at the Reception Display block off short-term time window that affect call-in reservations. The restaurant staff accepting call-in reservations is provided the information from the Reception Display at the Reservation Display. Hence, call-in reservations limit table availability for walk-ins at the Reception Display, and walk-ins entering table queues at the Reception Display limit short-term availability for those calling in.

Once a table becomes available, as identified by the bill being settled and the party leaving, the service staff can access the Table Status Display and interact with a touch screen function that sets the table status to “Available”. This table status is then passed to the RMS function. The RMS function may call the first party in the queue that can be seated at that table size using various methods. First, a recording may call “Table for party of 4 ready” repeatedly for a predetermined period of time and may flash the name of party on the screen (this also assists the service staff in identifying the party). Alternatively, the RMS function may interface with existing flasher/buzzer devices that customers carry with them until their tables are ready. The RMS function may be notified that the party has been seated when the table registers an E-Menu at the table, or when the service staff so indicates on the Reservation Display. A member of the service staff may accompany the party to their table. If a party does not arrive in a pre-determined timeframe, the RMS system may move on the next party in the queue.

The Reception Management System may also provide an optional mapping application that displays the floor and table layout of the dining area. This allows new customers to determine the location of tables and to specify preferences for specific tables. When a table becomes available, customers can determine where to go thereby eliminating the need for the service staff to accompany them. The :mapping application also displays the number of the available table. Each table at a RAS equipped restaurant may also have a numeric display to facilitate finding the table. Finally, if the table is equipped with a TCU, and the RMS function receives notice that a table has become available and calls the waiting party, it may send a signal to the table's TCU unit, to emit a signal such as a pattern of light flashes thereby making it easier to find for the diners.

RMS Process Flow Concept

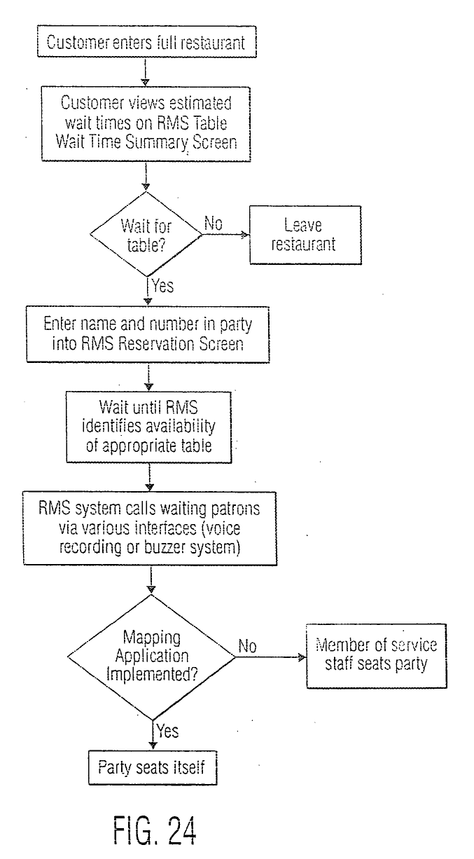

FIG. 24 depicts the process a “walk-in” customer entering a restaurant would follow to make a reservation after deciding that he wants to wait for a table. Once the RMS identifies that a table has become available for a party of a particular size, various methods of calling the party may be implemented including using voice calling or interfacing to a buzzer system as described above.

Once the party has been identified, a member of the common service staff may direct the party to the table or a mapping application may be used to extend the RMS functionality as described above.

Customer Personalization System

The Customer Personalization System addresses concerns that the RAS may be impersonal and that it removes the personalization that a waiter can provide. The CPS function residing on the restaurant's RAS compute server maintains a data store of customer IDs of those who choose to participate in the CPS program. CPS provides a high level of meal behavior tracking and provides benefits to RAS restaurant customers at a level that is not possible by individual waiters.

The core of the CPS operates centrally at the RAS Central Service Center and thereby can track meal patterns and preferences for customers based on a customer ID over all RAS equipped restaurants. The CPS can then apply focused advertising via the E-Menu and discount benefits automatically to patrons that exhibit certain dining patterns or provide a certain level of patronage. The CPS thereby provides a powerful means by which the restaurant industry can attract and retain more patrons and provide advertising and marketing channels.

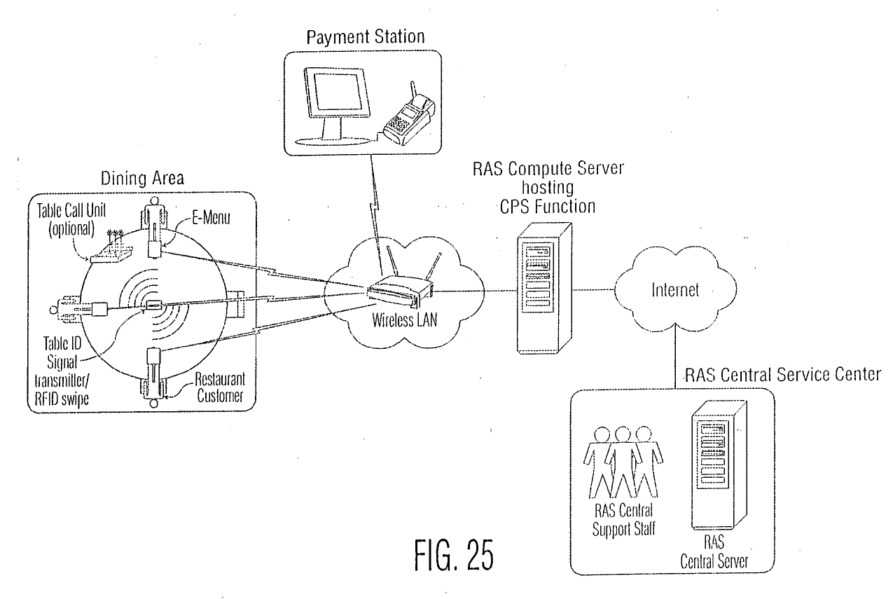

The Automated Ordering System function maintains data on customer dining patterns such as types of meals ordered, patronage frequency, etc. in its data store. This information can also be shared with information from other RAS restaurants and compiled at the RAS Central Service Center over an Internet or dial up link. Hence, customer specific information can be collected across many RAS equipped restaurants. This information can be used to personalize service for specific customers. For example, a customer who shows a pattern of consuming kosher meals can be sent specific recommendations and meal suggestions or can be sent specific hyperlinks to advertiser's website to internet sites for kosher restaurants or services. Customers may be identified by a specific RAS customer ID. FIG. 25 depicts the CPS Architecture.

CPS Function on Restaurant RAS Compute Server

When CPS participants enter a RAS equipped restaurant, they may walk up to a Payment Station and access the CPS function. In the CPS function, they may enter their customer ID and table number. The CPS function on the restaurant's RAS compute server then accesses the customer's data from the RAS Central server at the RAS Central Service facility. The primary data retrieved are: 1) the customer's membership level which indicates a level of patronage of money spent at RAS restaurants and 2) any preferences for food types (kosher, vegetarian, etc). Other data may also be retrieved. Based on this information, the restaurant's CPS function may focus specific advertising to the E-Menu's at the customer's table or call attention to specific items that may be of interest. Additionally, the RAS system may have arrangements with special interest organizations and marketers, etc. that may want to direct focused advertising to specific groups via the E-Menu platform. This may provide an additional revenue stream for the restaurant industry. Additionally, when the customer initiates the bill payment process, the AOS function queries the CPS function to see if the table qualifies for discounts. The CPS function will use the customer's patronage level to determine a discount level and forward this to the AOS function's billing process. The discounted bill is then sent to the Payment Station.

CPS Function on RAS Central Server

The CPS function on the RAS central server maintains the central repository of all frequent RAS restaurant diner information such as:

Customer IDs

Patronage level

Cuisine preference

Other data may also be maintained. The RAS central server receives this information regularly from RAS equipped restaurants via the Internet or dial up means—either on an event-by-event basis or via daily or weekly uploads. The RAS Central server dispenses this information to a RAS restaurant when a frequent CPS customer enters his customer ID at a Payment Station and the restaurant's RAS compute server makes a request to the RAS central server. The RAS Central server then downloads the customer patronage level and cuisine preference information to the restaurant's RAS compute server via the Internet or dial up means. This information is then used for specific advertising/marketing activities via the E-Menu and for applying discounts as described above.

As described in the previous section, there may be customers who decide to proactively participate in and become members of the CPS frequent diner function. These customers are assigned a customer ID. However, there may be customers who choose not to proactively participate in the CPS function or who do not know of it. These customers may frequently dine at RAS restaurants. To provide an automated benefit to these customers, the CPS function on the RAS central server tracks bill payment by credit card number. Each time a customer dines and makes a credit card payment, the credit card information, meals ordered, etc. information is stored on the restaurant's RAS Compute server as described in the AOS function section. This information is regularly uploaded to the RAS central server. The RAS central server has intelligent processes that scan through this data and can identify customers based on credit card numbers, which may qualify for specific discounts based on their dining frequency. When the RAS Central server identifies that someone qualifies for a discount, it performs a broadcast download of the credit card information to the RAS compute servers of all RAS equipped restaurants. The RAS compute servers of the restaurants maintain this frequent diner credit card number in a table within its data store. When that specific customer dines at a RAS restaurant and swipes his credit card during the payment process, the AOS function queries the CPS function to see if the credit card is in the frequent diner list. If it is, the CPS function returns a discount value as suggested by the RAS central server.

Hence, this system offers a novel method of granting frequent diner benefits completely automatically with no customer involvement or intervention.

CPS Process Flow

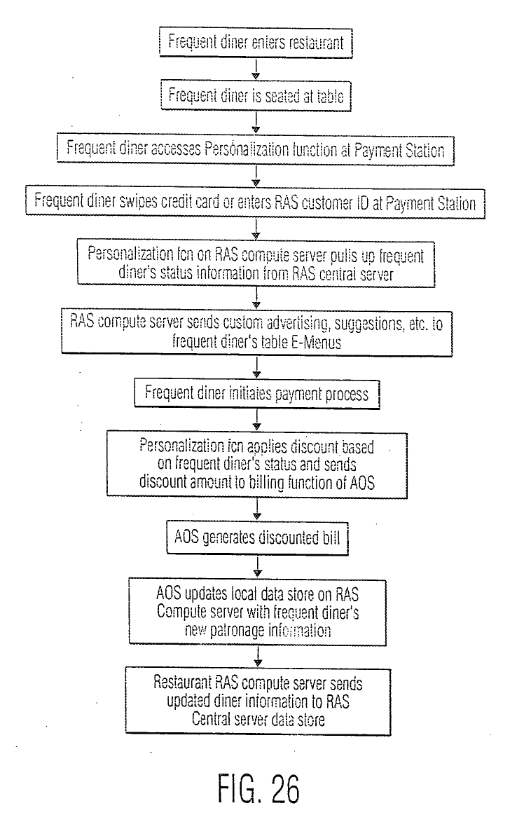

FIG. 26 depicts the process flow associated with the CPS function for a customer who participates in the CPS function and has a customer ID. Note that for a customer who does not participate in the CPS function, as the customer swipes his credit card to pay for their meal, the CPS function would automatically detect the customer's dining frequency and habits and apply the appropriate benefits, such as discounts.

E-Menu Screens

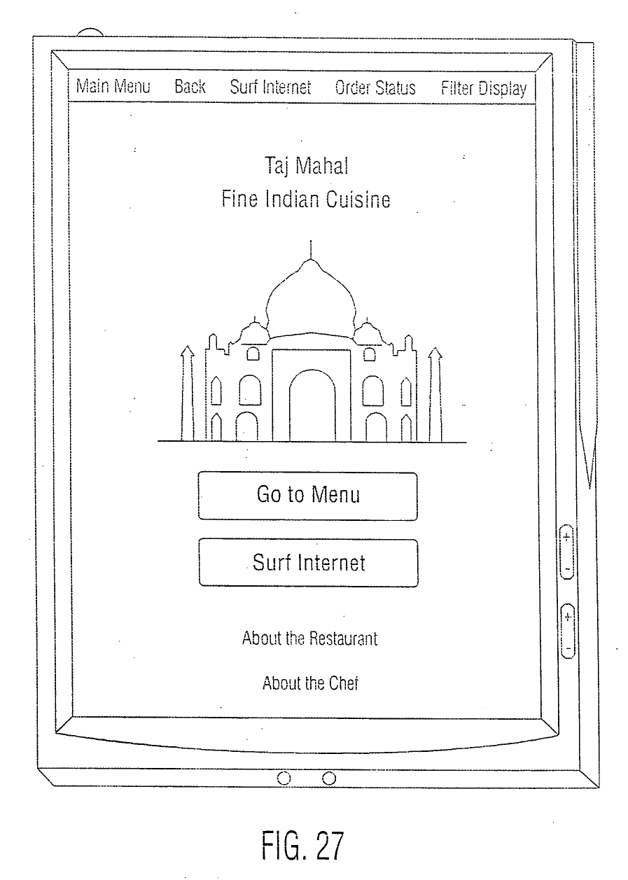

FIG. 27 depicts a sample home screen. This is the first screen that would be presented on an E-Menu to a diner. It provides the choice of viewing the menu or accessing the Internet.

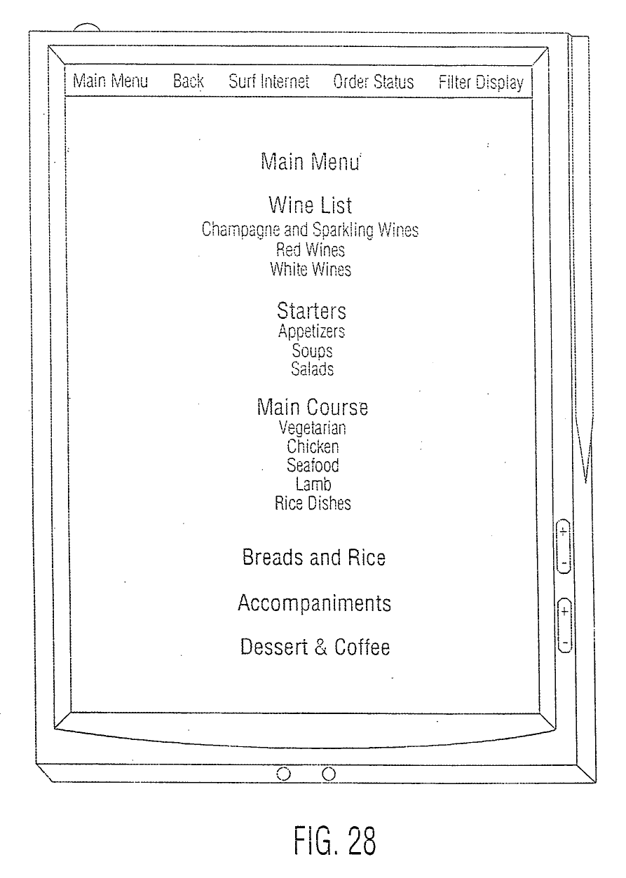

FIG. 28 depicts the main menu screen from which diners can navigate into sub menus for particular meal courses.

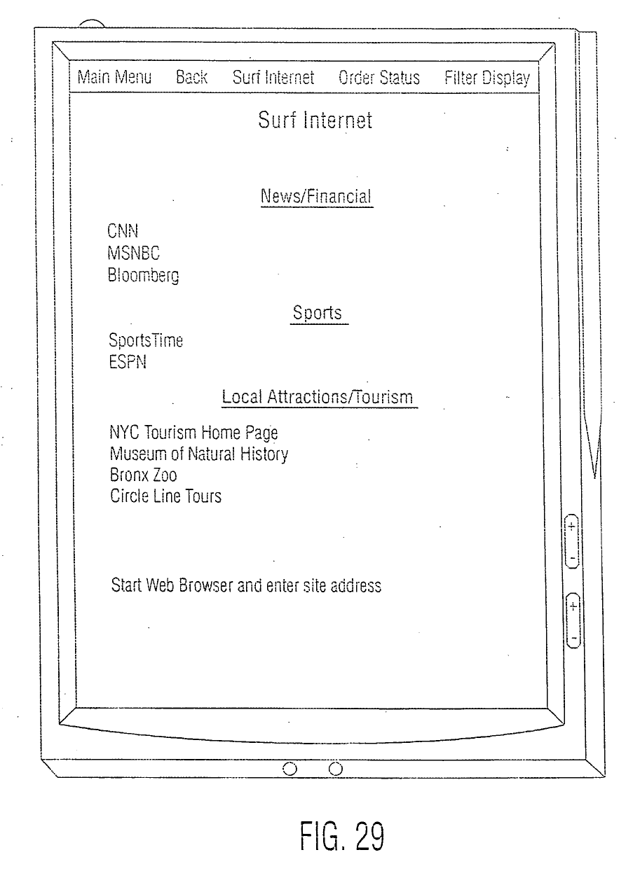

FIG. 29 depicts the home screen for Internet surfing. A diner can choose pre-defined sites thereby eliminating the need to enter an URL address or can open a browser and type a specific address.

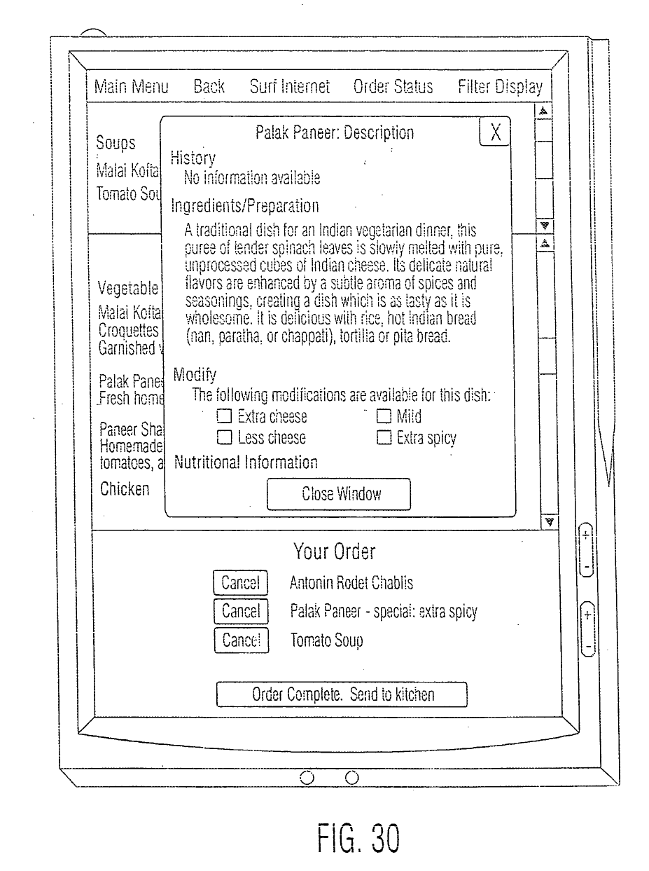

FIG. 30 depicts a pop-up detailed description screen that provides more information on a particular menu choice.

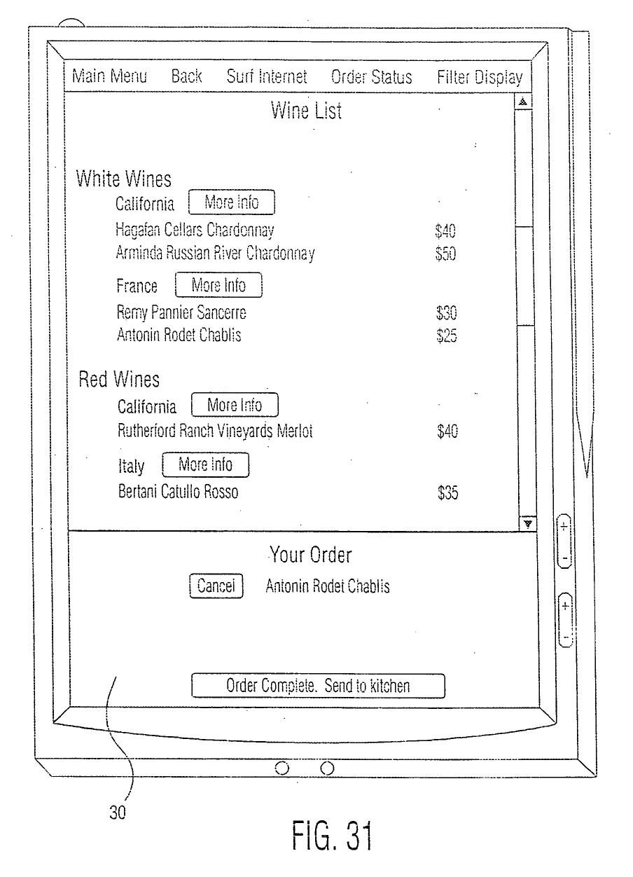

FIG. 31 depicts a sub menu for a particular meal course-e.g., wine list. Note that a running “Your Order” screen, 30, is provided that maintains a list of items the diner has placed on his order. When ordering off a submenu, the touch-screen selection provides a vast improvement over prior automated ordering system that required diners to correctly enter the codes or numbers that are associated with the desired item. The requirement to enter such designators only provides a chance to make an error, and unnecessarily tests the diner on information (e.g., the codes) known better to the restaurant staff. This testing can detract from the pleasure and purpose of restaurant dining.

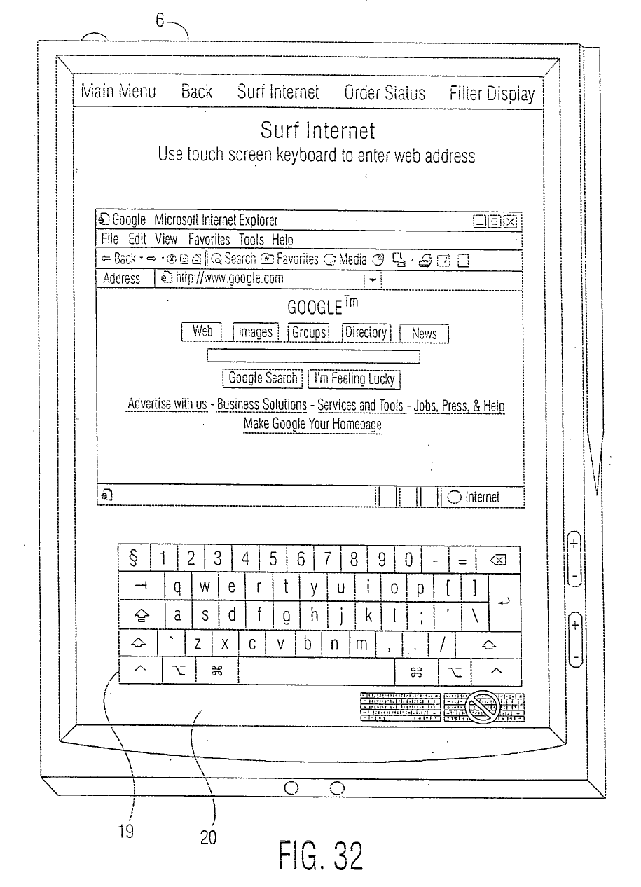

FIG. 32 depicts the Internet access screen in which diners can type in a specific URL to visit a specific web site using a “soft” keyboard 19.

FIG. 33 depicts the split screen functionality of the E-Menu allowing 2 courses, or sub-menus, to be viewed simultaneously as with a traditional hard copy menu. With this function, the diner may bring up a window for each course, and scroll through the offerings, while viewing the selections for another course in another window. While the definition of courses may differ from restaurant to restaurant, and menu to menu, what is intended by this function is to achieve a scrollable window for each sub-menu or section of the menu. In fact, each hyperlink in the E-menu can bring up a new window.

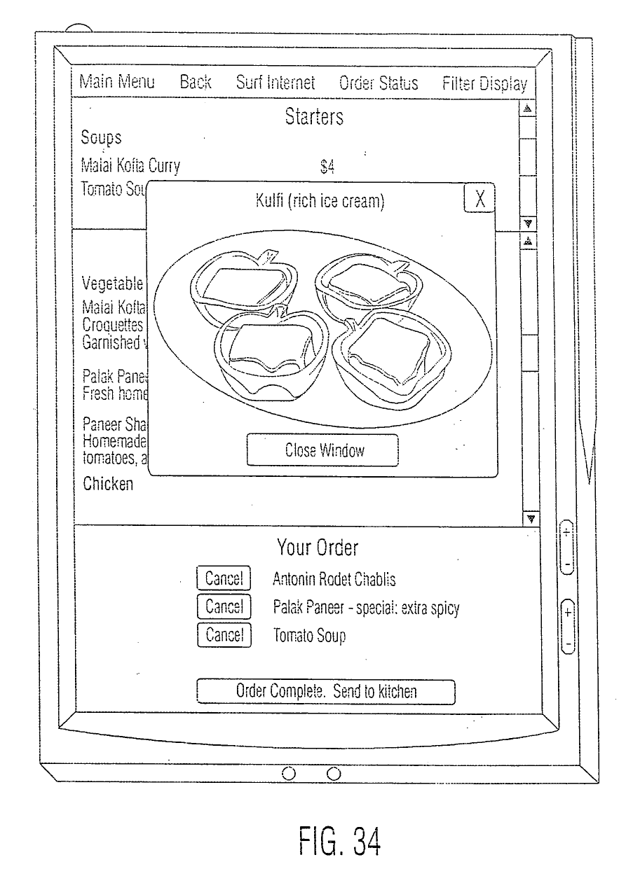

FIG. 34 shows a photo screen of a menu item, provided according to a preferred embodiment of the E-menu of the present invention.

FIG. 35 depicts the Filter Display function 39 that allows diners to specify categories of menu items that should be displayed according to various filters.

FIG. 36 illustrates a Bi-Fold E-menu, with a second screen, 37. This E-menu has been provided with speakers, 35, for playing music selected precisely for the table. Specific tables (premium, by reservation, or other criteria) may be fitted with small speakers with which an E-Menu may interface. The E-Menu may receive streaming audio files, which may be heard via the E-Menu's built-in speakers or via the table's speaker system. E-menu audio output jack, 39, attaches to an audio input jack in the tables, which in turn is connected to a speaker or speakers in or about the table. Finally, the RAS Central Server also contains a repository of music files that is downloaded to various subscribing restaurants on a rotational or trend-driven basis. Patrons using the E-Menu can then listen to these music files via streaming audio from the local restaurant RAS compute server.

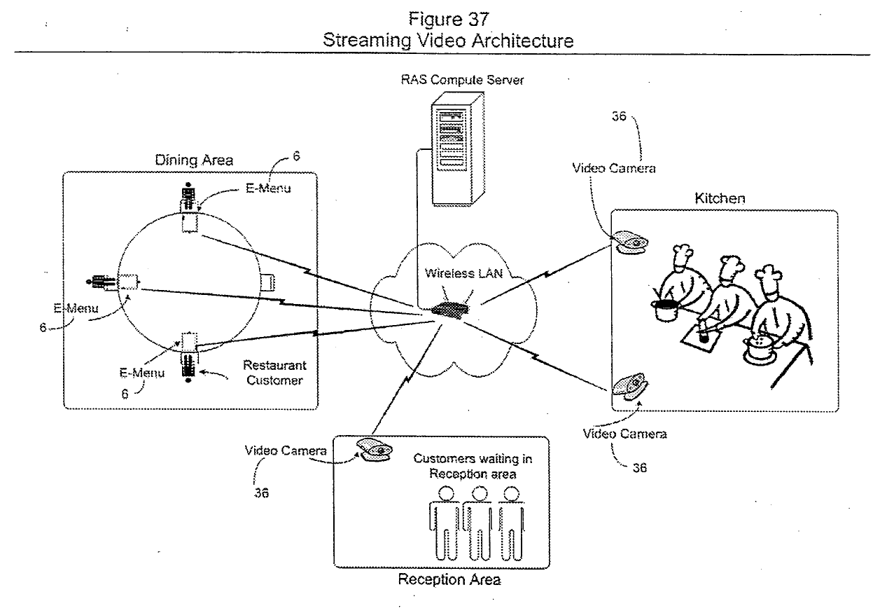

FIG. 37 illustrates an RAS for a restaurant in which particular areas, such as the kitchen or reception area, may be fitted with video cameras, 36, as shown, that can feed streaming video signals to specific E-Menus. This allows patrons to view food preparation in the kitchen, or the people waiting in lines at the reception area. Note, the ability of the e-menu to display video may also be used to provide pre-taped videos of sample preparations of menu selections.

Each video camera provides a wireless interface that may send the video signal to the RAS compute server. The RAS compute server may then transmit the signal to any E-Menu requesting a particular view. The RAS compute server may reduce the frame per second count of the video based on network bandwidth available or based on the current E-Menu processing/display technology used.

Alternatively, each video camera may provide an interface accessible directly by an E-Menu. In this implementation, a user may simply log onto a pre-defined Universal Record Locator (URL) address from an E-Menu to view a particular camera's video feed.

Regardless of the implementation, the spirit of the feature is to provide diners with visibility into areas of the restaurant that are not usually visible in traditional restaurants.

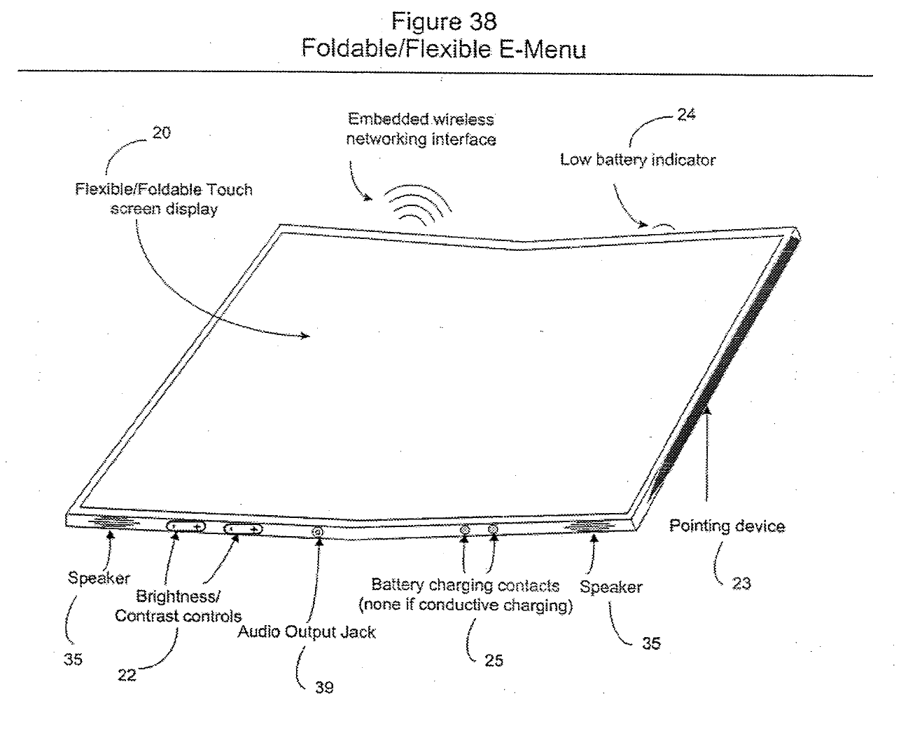

FIG. 38 illustrates a Foldable/Flexible E-menu, having one screen. It is this construction that will provide the closest approximation to traditional, large, folded, heavy weight paper menus, with which diners are most accustomed. This menu functions in all other ways like the E-menu of FIG. 36.

The Restaurant Automation System increases the efficiency of the dining experience and reduces the amount of time customers unnecessarily occupy a table waiting for service. For the restaurant, this provides the benefit of turning tables more quickly and thereby increasing revenue. Operational cost is reduced because many front-end processes are automated. Customers are provided greater control over their dining experience because they get what they want, when they want it. For example, appetizers and the main course can be timed by the customer to ensure that both courses arrive hot when the customer is ready for them. Bill payment can be made at anytime without having to rely on the arrival of the check. This ultimately eliminates variation in dining times and provides a predictable, controlled dining experience. Customers can tailor their meal to the exact time that is appropriate for their schedule.

Finally, the Restaurant Automation System provides a more comfortable dining experience by eliminating sometimes-intrusive visits by waiters/waitresses for satisfaction inquiries, water refills, plate removal, etc. The Restaurant Automation System puts the customer in complete control of when service personnel arrive and for what purpose.

There has thus been shown and described a novel Restaurant Automation System which fulfills all the objects and advantages sought therefore. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. Restaurant automation system (RAS) comprising,
a) a restaurant compute server for making operational a server application comprising
i) data storage of restaurant operations data, comprising inventory and menu information, comprising a list of food offerings and prices associated therewith, and
ii) means for calculating a bill for a selection of food offerings, said server in wireless communication with
b) a kitchen order display,
c) a pay station comprising bill payment means, and
d) a plurality of portable wireless menu means comprising
i) a display of food offerings, and prices, and
ii) means for transmitting a wireless message comprising a selection of the food offerings and table ID to the wireless server, which transmits the message to the kitchen order display, and
iii) means for transmitting a compute command to the server, which calculates a bill for the food items selected on the menu means, and transmits the computed bill to the payment station;
wherein each diner may be provided with a portable wireless menu means from which to order food, and request a bill, at the time determined by the diner.

2. RAS of Claim,1, wherein the menu information further comprises pictures of food offerings.

3. RAS of claim 1, wherein the menu information further comprises a display of nutritional content.

4. RAS of claim 1, wherein the menu information further comprises a display of the chef's background.

5. RAS of claim 1, wherein the menu information further comprises a display of the restaurant history.

6. RAS of claim 1, wherein the kitchen order display further comprises means for transmitting a message to the server that preparation is completed for a selected food offering, and it is ready to be served.

7. RAS of claim 1, the kitchen order display further comprises a touch screen w/touch activated location for transmitting a “prep started” message for a particular food offering to server, which message is accessible from the wireless menu means from which the selection was made.

8. RAS of claim 1, wherein the kitchen order display further comprises means to print food offering selections transmitted from the server.

9. The kitchen order display of claim 8, further comprising a touch screen print command.

10. RAS of Claim 1, wherein the server application further comprises display of bill for food offerings selected.

11. RAS of claim 1, wherein the server application further comprises a display of the bill for selections made on another wireless menu means.

12. RAS of claim 1, wherein the server application further comprises means for calculating a bill.

13. RAS of claim 1, wherein the server application further comprises means for displaying advertising on the E-menus.

14. An E-menu of the RAS of claim 1, wherein server application further comprises means for accessing the Internet.

15. RAS of claim 1, server application further comprising menu modify function operable thru a menu modify screen, to upgrade food offerings and billing, on the E-menus.

16. RAS of claim 15, wherein menu modify screen has touch screen, commands.

17. RAS of claim 1, wherein the server application further comprises mean to collate orders received from particular table.

18. RAS of claim 17, further comprising means to collate late orders with earlier order.

19. RAS of claim 1, wherein the server application further comprises means for requiring confirmation of an order placed on a particular menu.

20. RAS of claim 1, wherein the server application further comprises filtering means for selecting among categories of food offerings.

21. RAS of claim 1, wherein the server application further comprises means for transmitting fast and easy updates to the menu means.

22. RAS of claim 1, server application further comprises means for customizing the design of the menu.

23. RAS of claim 1, wherein the server application permits simultaneous viewing of two or more separate windows in the screen of the E-menu.

24. RAS of claim 1, wherein the E-menu permits simultaneous viewing of two or more separate windows in the screen of the E-menu.

25. RAS of claim 1, wherein the server application further comprises a means for adjusting a bill.

26. RAS of claim 1, wherein portable wireless menu means comprises an E-menu with a Dot Matrix Screen.

27. RAS of claim 1, wherein portable wireless menu means comprises an E-menu with a touch activated LCD screen.

28. RAS of claim 1, wherein the E-menu further comprises a second touch activated LCD screen, hinged to the first.

29. RAS of claim 27, wherein the LCD screens is foldable.

30. RAS of claim 27 wherein the LCD screen is rollable

31. RAS of claim 1, wherein portable wireless menu means comprises an E-menu with a first touch activated OLED screen.

32. RAS of claim 31, wherein the E-menu further comprises a second touch activated OLED screen, hinged to the first.

33. RAS if claim 31 wherein the OLED screen is foldable.

34. RAS of claim 31 wherein the OLED screen is rollable.

35. RAS of claim 1, wherein the wireless menu means further comprises a hyper-text linked, touch activated display of menu information.

36. RAS of claim 1, wherein the wireless menu means further comprises means for checking the status of the preparation of an offering selected.

37. RAS of claim 1, wherein the wireless menu means further comprises means for transmitting a “selection cancelled” message to KITCHEN ORDER DISPLAY, which further comprises means to display said message.

38. RAS of claim 1, the wireless menu means further comprises a means to disable the order send function.

39. RAS of claim 1, wireless menu means further comprises means for requesting a separate check for the items ordered on that menu means.

40. An E-menu of the RAS of claim 27, wherein said LCD screen is foldable.

41. An E-menu of the RAS of claim 27, further comprises low battery indicator.

42. An E-menu of the RAS of claim 27, wherein the E-menu further comprises battery charging contacts

43. An E-menu of the RAS of claim 27, wherein the E-menu further comprises brightness/contrast controls.

44. An E-menu of claim 1, further comprising wireless network interface embedded in E-menu.

45. RAS of claim 1, wherein the Payment Station further comprises means for making credit card payment.

46. RAS of claim 1, wherein the Service Management Function of the RAS Server further comprising data storage of messages transmitted on system, and means for reviewing the data to evaluate restaurant.

47. RAS of claim 1, further comprising a Central Server for transmitting and receiving data from a Central Services Center, said Central server in communication with at least the RAS of claim 1.

48. RAS of claim 47, wherein the Central Server further comprises means to analyze the data received from one or more RAS systems.

49. RAS of claim 1, wherein the RAS Server functions further comprise a Customer Personal Benefit System, and means for entering a dinner ID for a patron, and means for assigning benefits to the diner ID.

50. RAS of claim 49, further comprising means for a diner to request an ID.

51. RAS if claim 1, wherein the Payment Station further comprises means for a diner to enter a Customer Personal Benefit ID.

52. RAS of claim 1, wherein the Payment Station further comprises means for displaying the Table Status function.

53. RAS of claim 49, further comprising means for directing advertising messages to menus according to the data store of info related to diner ID.

54. A Waiter Call System (WCS) for the RAS of claim 1, comprising a Table Call Unit (TCU) with particular service call buttons, which operate to illuminate service call lights.

55. WCS of claim 54, wherein the TCU service lights further comprise decorative component.

56. WCS of claim 54, wherein the TCU further comprises a timer display for displaying the time elapsed since activation of a service call button

57. WCS of claim 54, wherein the TCU further comprises a table ID signal transmitter, and the WCS further comprises a Call Status Display.

58. WCS of claim 54, wherein the TCU further comprises a table ID signal RFID swipe device, for electro-magnetically affixing a table ID to the E-Menu.

59. A Waiter Call System (WCS) for a restaurant, said WCS comprising a Table Call Unit (TCU) comprising a plurality of service call buttons, each associated with a particular service, which operate to illuminate a plurality of service call lights.

60. The WCS of claim 59, wherein the TCU further comprising a decorative component illuminated by the service call lights.

61. The WCS of claim 59, wherein the TCU further comprises a timer display displaying the time elapsed since activation of a service call button.

62. The WCS of claim 59, wherein the TCU further comprises a table ID signal transmitter and the waiter call system further comprises a call status display which displays the table ID and service requests for that table.

63. The WCS of claim 59, further comprising a server in wireless communication with the TCU.

64. RAS of claim 1, further comprising a Reception Management system (RMS), comprising a Reception Management Display, and the RAS Server application further comprises a Reception Management System application which comprises means for entering and displaying reservations, and means for calculating expected wait times.

65. RAS of claim 64, wherein the RMS further comprising means for diner to enter queue for table of particular size.

66. RAS of claim 64, wherein the RMS further comprises a Reservation Display, displaying existing reservations, and means to enter new reservations.

67. RAS of claim 64, wherein the RMS further comprises means for calculating and displaying the expected wait time for an occupied table.

68. RAS of claim 64, wherein the RMS further comprises means to associate a table ready message with a particular table.

69. RAS of claim 68 wherein the RMS further comprises means to assign a reservation to an open table, and means for communication the assignment to the diners.

70. RAS of claim 69, wherein the means of communication is flashing lights.

71. RAS of claim 68, wherein the RMS further comprises means for directing diners associated with a reservation to the table assigned to the reservation.

72. RAS of claim 71, wherein the means for directing, comprises flashing lights located in the vicinity of the table.

73. RAS of claim 71, wherein the means for directing comprises a map.

74. RAS of claim 64, further comprising means for displaying a plot of the tables, and means for a diner to select a particular table.

75. An order automation system (AOS) comprising:
(a) a computer server having a memory unit for storing menu data comprising menu items which may be ordered;
(b) a first T/R device connected to server for transmitting said menu data and receiving order commands; and
(c) a plurality of menu tablets each having a graphic display, input means for receiving order commands from a user and a second (T/R device), said second T/R device, in communication with said first T/R device, for receiving said menu data from, and transmitting said order commands to, said server;
the improvement wherein the input means is a touch activated LCD screen.

76. The AOS of claim 75, wherein said LCD screen is foldable.

77. The AOS of claim 75, menu data further comprising a price for each menu item.

78. The AOS of claim 77, further comprising a pay station, in communication with said server, for receiving price tally commands; and said second T/R transmitting price tally commands from said tablets to said server.

79. The AOS of claim 78, further comprising a central facility comprising a central computer in communication with at least one order automation system, said central computer having a memory unit for storing the order commands from a number of order automation systems, and payment information associated therewith.

80. The AOS of claim 79, wherein the central computer memory unit further stores payment information associated with the order commands.

81. The AOS of claim 75, wherein the graphic display transmitted from the server comprises pictures of the menu items.

82. The AOS of claim 75, wherein the graphic display transmitted from the server comprises compatibility information for the menu items.

83. The AOS of claim 75, further comprising a facility's order display in communication with said server, for receiving and displaying order commands received from the computer server.

84. The AOS of claim 83, wherein said facility's order display further comprises a graphic display, and a third (T/R device) in communication with said first T/R device, for receiving said order commands, and transmitting an order work started command to the server.

85. The AOS of claim 83, wherein said facility's order display further comprises a third transmitting and receiving device (T/R device) in communication with said second T/R device, for receiving said order commands, and transmitting a “food preparation started” command to the server.

86. The AOS of claim 83, wherein said facility's order display further comprises a third transmitting and receiving device (T/R device) in communication with said second T/R device, for receiving said order commands, and transmitting a “food preparation completed” command to the server.

87. The AOS of claim 85, and wherein the diner can check the status of food preparation via an E-Menu.

88. The AOS of claim 75 wherein the menu tablets further comprise a low battery indicator.

89. The AOS of claim 75 wherein the menu tablet further comprises battery charging contacts.

90. The AOS of claim 75 wherein the menu tablets further comprise brightness/contrast controls.

91. The AOS of claim 75 wherein the menu tablet further comprises means for accessing and viewing the Internet connection of the server.

92. An order automation (AOS) system:
(a) a computer server having a memory unit for storing menu data comprising menu items which may be ordered;
(b) a first T/R device connected to server for transmitting said menu data and receiving order commands; and
(c) a plurality of menu tablets each having a graphic display, input means for receiving order commands from a user and a second (T/R device), said second T/R device, in communication with said first T/R device, for receiving said menu data from, and transmitting said order commands to, said server;
the improvement wherein the menu tablets comprise means for sensing the location of the tablet within the facility.

93. AOS of claim 92, wherein said menu tablet comprising a foldable LCD screen.

94. AOS of claim 92, wherein said menu data further comprising a price for each menu item.

95. AOS of claim 94, further comprising a pay station, in communication with said server, for receiving price tally commands; and said second T/R transmitting price tally commands from said tablets to said server.

96. AOS of claim 94, further comprising a central facility comprising a central computer in communication with at least one order automation system, said central computer having a memory unit for storing the order commands from a number of order automation systems, and payment information associated therewith.

97. AOS of claim 95, wherein the central computer memory unit further stores payment information associated with the order commands.

98. AOS of claim 92, wherein the graphic display transmitted from the server comprises pictures of the menu items.

99. AOS of claim 92, wherein the graphic display from the server comprises compatibility information for the menu items.

100. AOS of claim 92, further comprising a facility's order display in communication with said server, for receiving and displaying order commands received from the computer server.

101. AOS of claim 100, wherein said facility's order display further comprises a graphic display, and a third (T/R device) in communication with said first T/R device, for receiving said order commands, and transmitting a “food preparation started” command to the server.

102. AOS of claim 100, wherein said facility's order display further comprises a third device (T/R device) in communication with said second T/R device, for receiving said order commands, and transmitting a “food preparation started” command to the server.

103. AOS of claim 100, wherein said facility's order display further comprises a third device (T/R device) in communication with said second T/R device, for receiving said order commands, and transmitting a “food preparation completed” command to the server.

104. AOS of claim 102, and wherein the diner can check the status of food preparation via an E-Menu.

105. AOS of claim 92 the menu tablet further comprising a low battery indicator.

106. AOS of claim 92 the menu tablet further comprising battery charging contacts.

107. AOS do claim 92, the menu tablet further comprising brightness/contrast controls.

108. AOS of claim 92 the menu tablet further comprising means for accessing and viewing the Internet connection of the server.

109. An order automation system comprising, in combination:
(a) a computer server having a memory unit for storing menu data comprising menu items which may be ordered;
(b) a first T/R device connected to server for transmitting said menu data and receiving order commands; and
(c) a plurality of menu tablets each having a graphic display, input means for receiving order commands from a user and a second transmitting and receiving device (T/R device), said second T/R device, in communication with said first T/R device, for receiving said menu data from, and transmitting said order commands to, said server; the improvement wherein the menu tablets have no CPU.

110. AOS of claim 109, wherein said menu tablet comprises a foldable LCD screen.

111. AOS of claim 109, wherein said menu data further comprises a price for each menu item.

112. AOS of claim 111, further comprising a pay station, in communication with said server, for receiving price tally commands; and said second T/R transmitting price tally commands from said tablets to said server.

113. AOS of claim 112, further comprising a central facility comprising a central computer in communication with at least one order automation system, said central computer having a memory unit for storing the order commands from a number of order automation systems, and payment information associated therewith.

114. AOS of claim 113, wherein the central computer memory unit further stores payment information associated with the order commands.

115. AOS of claim 109, wherein the graphic display transmitted from the server comprises pictures of the menu items.

116. AOS of claim 109, wherein the graphic display transmitted from the server comprises compatibility information for the menu items.

117. AOS of claim 109, further comprising a facility's order display in communication with said server, for receiving and displaying order commands received from the computer server.

118. AOS of claim 117, wherein said facility's order display further comprises a graphic display, and a third transmitting and receiving device (T/R device) in communication with said first T/R device, for receiving said order commands, and transmitting an order work started command to the server.

119. AOS of claim 117, said facility's order display further comprises a third transmitting and receiving device (T/R device) in communication with said second T/R device, for receiving said order commands, and transmitting a “food preparation started” command to the server.

120. AOS of claim 117, said facility's order display further comprises a third transmitting and receiving device (T/R device) in communication with said second T/R device, for receiving said order commands, and transmitting a “food preparation completed” command to the server.

121. AOS of claim 119, and the diner can check the status of food preparation via an E-Menu.

122. AOS of claim 109 the menu tablet further comprising a low battery indicator.

123. AOS of claim 109 the menu tablet further comprising battery charging contacts.

124. AOS of claim 109 the menu tablet further comprising brightness/contrast controls.

125. AOS of claim 109 the menu tablet further comprising means for accessing and viewing the Internet connection of the server.

126. An order automation system for a restaurant, comprising, in combination:
(a) a computer server having a memory unit for storing menu items which may be ordered;
(b) a first transmitting and receiving device (T/R device) connected to said server for transmitting said menu data and receiving order commands;
(c) a plurality of ordering menus each having input means for receiving order commands, and a second transmitting and receiving device (T/R device), said second T/R device, in communication with said first T/R device, for transmitting said order commands to, said server;
(d) a plurality of viewing menu tablets each having a touch activated screen, and a re-programmable memory for a rich content, hypertext-linked, graphic display of restaurant information comprising descriptions of menu items; and means for reprogramming the tablet memory, in communication with a reprogramming input port;
(e) a viewing menu docking station, for reprogramming the viewing menu memory, said docking station in communication with said server, and comprising at least one interface port, which locks to the reprogramming input port of the viewing menu;
(f) a kitchen order display, in communication with the computer server, for displaying the selection of menu items ordered.

127. The order automation system of claim 126, wherein the ordering menus receive menu data from the server.

128. The order automation system of claim 126, further comprising means for reprogramming menu items on the server.

129. The order automation system of claim 110, wherein the viewing menu docking station is connected to the server.

130. The order automation system of claim 126, wherein said ordering menus further comprise means for transmitting comments regarding the order to the server.

131. The order automation system of claim 126, wherein the kitchen order display further comprises means for transmitting a “prep started” message to the server, and the ordering menus further comprise means for receiving said message from the server.

132. The order automation system of claim 126, wherein the kitchen order display further comprises means for transmitting an “order ready” message to the server, and the ordering menus further comprise means for receiving said message from the server.

133. The order automation system of claim 126, wherein the ordering menus further comprise means for free flowing digitalized text messages.

134. The order automation system of claim 126, further comprising a waiter call system as in Claim WCS1.

135. The order automation system of claim 126, further comprising a docking station for reprogramming a viewing tablet in the docking station, said docking station connected to said server, and said viewing tablet being re-programmable from the order display.

136. The order automation system of claim 126, further comprising a docking station for reprogramming a viewing tablet in the docking station, said docking station connected to said server, and said viewing tablet being re-programmable from an ordering menu.
